(19) United States
(12) Patent Application Publication
(10) Pub. No.: US 2006/0155513 A1
(43) Pub. Date: Jul. 13, 2006

(54) Survey system

(75) Inventors: Aharon Ronen Mizrahi, Tenafly, NJ (US); Amir Meir Weisenstern, Hod Hasharon (IL)

Correspondence Address: WOLF, BLOCK, SCHORR & SOLIS-COHEN LLP, 250 PARK AVENUE, NEW YORK, NY, 10177, US

(73) Assignee: Invoke Solutions, Inc., Tenafly, NJ (US)

(21) Appl. No.: 10/534,136

(22) PCT Filed: Nov. 6, 2003
(86) PCT No.: PCT/IL03/00923

§ 371 Date: Feb. 22, 2006

Related U.S. Application Data
(60) Provisional application No. 60/424,328, filed on Nov. 7, 2002.

(51) Int. Cl. G06F 19/00

(52) U.S. Cl. 702/179

(57) ABSTRACT

A method of conducting a survey. The method includes providing a plurality of questions to respondents, at least some questions being provided to a plurality of the respondents, collecting answers to the questions from the respondents, transfer-ring at least some of the answers to respondents other than those who generated the answers, collecting responses to the transferred answers, at least some of the responses being qualitative, and providing a statistical report which is at least partially based on qualitative responses collected from the respondents.

### RELATED APPLICATIONS

The present application is a continuation in part (CIP) of U.S. patent application Ser. No. 10/258,822, filed on Oct. 25, 2002, which is a national phase of PCT patent application PCT/IL01/00391, filed on May 1, 2001, which claims the benefit under 119(e) of U.S. provisional patent application 60/200,837, filed on May 1, 2000. The application also claims the benefit under 119(e) of U.S. provisional patent application 60/424,328, filed on Nov. 7, 2002. The disclosure of all of these applications are incorporated herein by reference.

### FIELD OF THE INVENTION

The present invention is related to the field of performing surveys, for example surveys in which the respondents discuss issues with each other.

### BACKGROUND OF THE INVENTION

Surveying prospective buyers for information is an important tool of industry in deciding on investments, for example in new products, their packaging, pricing and components. Surveying is also used in other fields, for example in politics and employee satisfaction/feedback.

Traditionally, surveys are performed by preparing a predetermined set of questions, selecting a group of respondents representing a population of interest and asking each of the people in the selected group, the questions in the predetermined set. The questions may be asked by a surveyor knocking on people's doors, in a shopping center, over the telephone and/or on a computer network. For example, US patent publication 2002/0128898, the disclosure of which is incorporated herein by reference, describes a method of assigning surveys to respondents, on the Internet. Surveys may also be provided to people gathered in a room to answer the questions. For example, when the survey requires presenting models to the respondents and/or requires expensive surveying apparatus, the respondents may be gathered for the survey in a specific location.

Many surveys include closed questions in which the respondents need to select one or more of answers provided with the question or give a rating of a statement (e.g., agree/disagree, between 1 to 5). Closed questions allow fast analysis of the answers, and therefore collection of data from a large number of respondents, but do not provide for idea collection from the respondents.

Some surveys include also open questions to which respondents answer in their own words. This allows for collecting ideas from the respondents but makes the analysis much harder. Half open questions (referred to herein also as half closed), in which answers are provided in accordance with a given structure, for example the respondent needs to state a single word or fill in a detail having a known structure (e.g., a telephone number), serve as a compromise between open and closed questions. Half open questions include also questions in which the respondent may enter free text as a last resort, for example if none of the given options are suitable.

A web site posted September 2001 describes an on-line survey system in which the answers of each of the respondents are displayed to the other respondents. The other respondents may vote for each answer using agree/disagree buttons. Thus, each answer provided by a respondent is immediately rated by the other respondents.

Another method of performing market research involves conducting focus group discussions in which a plurality of respondents discuss issues brought up by a moderator. Focus group discussions allow group thought, providing a much more powerful method of collecting input from respondents than closed questions or even open questions. Focus group discussions, however, are generally limited to about ten to fifteen respondents, so that the discussion does not flood the group with answers and comments which cannot be comprehended by the moderator. U.S. Pat. No. 6,256,663 to Davis, the disclosure of which is incorporated herein by reference, describes a system for moderating an on-line focus group.

In some cases, as in the '663 patent, a focus group over the Internet is conducted using a chat-room model in which all the users are connected to the Internet at the same time. In other cases, a focus group uses a message board model in which the respondents log in to the focus group in their free time and provide their comments. Use of a message board allows for a larger number of respondents, as the respondents have more time to read comments of others. However, a typical survey session according to this model has a duration of between about a few days to a few weeks. In this model there is also control over the survey and over the distribution of information. Thus, if large numbers of participants actually participate, the session may collapse under its own weight.

In some cases, a market research is performed in two stages. In a first stage, a large number of respondents answer questionnaires without any interaction, in order to collect large amounts of quantitative data. In a second stage, a small group of respondents is asked to remain for a focus group, in order to perform a discussion, which better collects qualitative data. The focus group may be performed also before quantitative data is collected, in preparation for a large scale survey, for example as suggested in PCT publication WO02/19232, the disclosure of which is incorporated herein by reference. In fact, some market research studies involve repeated interleaved quantitative surveys and focus group discussions until satisfactory results are achieved. This naturally is very costly and time consuming.

A survey service provided by Axiom Group includes showing slides to a plurality of respondents who use buzzers to rate the products shown in the slides. Based on the results of one of the questions, a client may suggest to post another question.

The above mentioned PCT publication WO02/19232 describes a system for conducting market research studies which includes a moderator computer and respondent computers connected over a network. The moderator directs the respondents to view preselected subject matter and collects reactions to the subject matter from the respondents. The reactions are described as including ratings and comments. The reactions are collected for later analysis, for example in order to build a large scale quantitative study. This PCT publication also includes a suggestion to perform studies on people located in a same room and after the reactions are collected perform an off-line discussion for additional information. The moderator may focus the respondents behavior, for example by forcing respondents to provide a comment before moving from one Web page to another.

A company named “Informative” suggests an adaptive survey system in which after a question is posted with a plurality of possible answers, each respondent may select one of the answers or may suggest another answer which is added to the answers posted with the question.

### SUMMARY OF THE INVENTION

A broad aspect of some embodiments of the invention relates to providing a moderator with tools for controlling interactive surveys, so as to achieve effective collection of statistically valid data. The tools are optionally adapted to control the survey session, in order to collect data based on statistical goals which are to be achieved. The control of the survey session may include, for example, the data exposure to respondents, which respondents take part and/or their biasing.

A broad aspect of some embodiments of the invention relates to tools for controlling interactive surveys (i.e., surveys with interaction between the respondents), having large numbers of participants. Such tools optionally allow a moderator of the survey to control the people taking part in a portion of the survey, in real time. For example, people may be added as needed to achieve a certain goal, or be removed (e.g., from certain questions), for example to prevent them being wasted or biased. Alternatively or additionally, the tools aid the moderator in assimilating large amounts of data, such that the data may be used during the survey session in directing the path of the survey.

In an exemplary embodiment of the invention, the provided tools allow decisions to be made in real-time while the survey is going-on, for example allowing an operator to make changes, as necessary, in a preplanned survey plan. In some embodiments of the invention, the surveys are carried out without a living moderator, or with intermittent intervention of such a moderator. In an exemplary embodiment of the invention, the tools are used for qualitative surveys and/or focus groups. Alternatively or additionally, the tools are used for quantitative surveys and/or focus groups. In a survey, quantitative and qualitative events may occur in parallel or in series (e.g., in cycles). The presentation of a stimulus, for example a product description, may start a new cycle of qualitative and quantitative events. It is noted that in some embodiments of the invention, also qualitative information is treated as quantitative, for example for display as a summary.

In some embodiments of the invention, the survey design includes enough slack to allow various mistakes to occur and still not prevent the final statistical validity of the results. In an exemplary embodiment of the invention, a pool of “spare” respondents is provided as one type of slack, for example, to allow additional respondents to be used for answering questions where a desired statistical confidence is not yet achieved. The bias of the respondents in this pool is optionally controlled.

A broad aspect of some embodiments of the invention, relates to controlling and/or managing bias in a survey. In an exemplary embodiment of the invention, answers received from respondents are marked (and later analyzed) in a manner which reflects one or more bias factors of the respondent, for example, what stimuli the respondent was exposed to and/or a previous slant of answers of that respondent. Alternatively or additionally, bias is controlled by changing the order of questions and/or other stimuli (e.g. product descriptions, respondent comments) to one or more respondents. Alternatively or additionally, bias is controlled by changing other aspects of timing, for example, delay. Alternatively or additionally, bias is controlled by controlling a degree of interactivity of a focus group, for example to assist and/or prevent cementing of ideas by the respondents. Alternatively or additionally, bias is controlled by an automated tool suggesting to send or not send data and/or preventing the sending of data, to control data.

A broad aspect of some embodiments of the invention, relates to context management. Typically, the context of a respondent indicates a bias of that respondent and/or may shade or otherwise impact the true meaning of answers or remarks given by a respondent. The context may be represented, for example, by the stimuli (or some of the stimuli, for example only product pictures) displayed to the respondent and/or the order in which the stimuli was displayed. A moderator may have difficulty in dealing with too many contexts. In an exemplary embodiment of the invention, the proliferation of contexts is limited, for example, by limiting the number of possible contexts (e.g., by forcing respondents to see certain stimuli). Alternatively or additionally, a set of contexts may be predefined. Alternatively or additionally, contexts may be defined (ad hoc and/or to begin with) in a manner which allows combining the contexts, for example results from two similar (in a statistically meaningful manner or user designed manner) contexts may be combined into a single value for a summary display.

In an exemplary embodiment of the invention, when an item of information is displayed, it is shown with a context, for example, a respondent answer is shown with a context of what stimuli the respondent was exposed to. Some actors, for example other respondents, may not be able to see some or all of such context information, for example, to reduce bias. When two contexts are combined, a manufactured context which indicates the common features of the contexts, is optionally shown.

In an exemplary embodiment of the invention, a context includes one or more of stimuli that the respondent was exposed to, order of such stimuli, type(s) of interactions the respondent took part in and/or which other respondents the respondent interacted with.

A broad aspect of some embodiments of the invention relates to automated supporting of a survey, for example to ensure the survey meets predetermined goals. Such support can include, for example, making suggestions to a moderator, preventing actions and/or creating questions. In an exemplary embodiment of the invention, an automated system is provided which monitors available resources (e.g., time, respondents, new concepts to be checked, moderator abilities, respondent abilities, stimuli and/or inducements) and makes suggestions how to apply the resources and/or whether one or more goals of the survey can be met. Optionally, the goals are prioritized and the system can plan resources for the goals, for example using planning methods well known in the art.

An aspect of some embodiments of the invention relates to the provision of methods and apparatus for conducting interactive survey sessions, in which respondents provide answers to questions and discuss surveyed issues with other respondents, during the same session.

The answers to at least some of the questions are collected in a manner which allows quantitative analysis of the answers. The discussion, on the other hand, provides, for example, free text input from the respondents, similar to input received in qualitative research, such as a focus group discussion. Alternatively or additionally, the discussion is used for obtaining ratings of entries by other respondents.

In an exemplary embodiment of the invention, quantitative data is collected by setting one or more statistical goals to be achieved and then controlling the survey so that these goals are achieved. In an exemplary embodiment of the invention, the statistical goals comprise achieving a proposition having a minimal agreement rate and/or a minimum statistical confidence level of the agreement rate. For example, one goal is to have at least one concept presented to be approved by at least x % of the respondents with at least y % confidence in the answer. In some cases an open-ended goal may be defined for example: a high as possible confidence level, but at least 75%. A more complex goal can also be defined, for example, that a certain type of statistical analysis may be performed at a later date. In one example, a plurality of sessions are set up (in parallel or consecutively), with each one being controlled so that the totality of sessions provide the desired goal and/or quantitative data. In an exemplary embodiment of the invention, what is required to achieve such confidence levels is a sufficiently large sample in which biases are controlled and/or prevented. Quantitative data, in general, is presented statistically, with confidence levels displayed or hidden. It is a feature of some embodiments of the invention, that also qualitative data is analyzed and/or displayed in a quantitative manner.

In some embodiments of the invention, the answers to the questions are provided by the respondents intermittently with the discussion. At the end of the survey session, a report including quantitative data summarizing the respondents answers to questions, is optionally generated. The report may optionally be in the form of tables and/or charts. The report may also include remarks and/or other data from the discussion. In some embodiments of the invention, the report provides explanations given by the respondents to the quantitative data of the report. The explanations are optionally taken at least partially from the discussion. Alternatively or additionally, the explanations are given as responses to open questions. Optionally, the report further includes quantitative data on the explanations given by the respondents.

In an exemplary embodiment of the invention, a report is displayed continuously or intermittently during the survey, for example to support real-time decision making, for example, for deciding what to change in goals of survey, where to put effort, how to expose data (and to who), what was completed and/or what to use respondents for. In an exemplary embodiment of the invention, the report is displayed as compared to one or more goals that were set for the survey, for example before the survey and/or during the survey. Goals can be, for example, statistical goals (e.g., confidence level over 75% on which product design is better liked) and/or qualitative information collection goals (e.g., at least four different reasons that a product is preferred over competition). In an exemplary embodiment of the invention, the goals are shown in an updating report table, showing for example, goals, how close the goals are to being met and/or whether there appears to be a problem in meeting the goals.

The term remarks is used herein to refer to respondent statements which are not answers to questions of the survey session. The remarks may relate to answers of other respondents, to questions of the survey and/or to remarks of other respondents or may be related to any other issue, such as to the quality of the stimuli or general remarks without relation to any specific statement. In some embodiments of the invention, at least some of the questions include closed and/or half closed questions which allow fast tabulation of the results.

By performing the discussion and the collection of quantitative data in the same session, the feedback of the discussion and of the quantitative data collection may be used instantaneously during the session. This provides better chances of reaching conclusions in a shorter period.

Interactive survey sessions are, typically, different from other sessions, such as on-line courses and presentations, in that survey sessions are intended primarily for collecting information rather than providing information. Therefore, for example, the respondents in a survey session are optionally selected based on statistical constraints so that the respondents properly represent a large group of interest. Alternatively or additionally, the questions provided to the respondents may be adjusted according to responses the respondents provided to previous questions. In addition, the flow of the session is optionally rigorously planned so that the session provides the desired information. The survey session may be performed for market research or for any other purpose.

Optionally, the survey report of the quantitative data includes data from a large enough group of people, such that the data is statistically valid, e.g., a group with at least 30-50 respondents, or even 100-200 respondents. In some embodiments of the invention, a qualified moderator and/or a staff of a moderator and observers may achieve statistically meaningful results even for 400-500 respondent or more, even many more. In an exemplary embodiment of the invention, moderators are used mainly for managing the technical side of the survey (e.g., controlling bias, statistical confidence level) and the observers are used for managing the content side, for example, reviewing real-time results and deciding if to change the goals of the survey. However, the moderator can do both functions. Alternatively, other distributions of functions between a moderator, his assistants and/or observers, may be provided.

In some embodiments of the invention, the survey report includes quantitative data from at least one additional survey session. Optionally, a plurality of survey sessions may be conducted at different times (or at the same time in parallel) using mostly the same or similar questions, in a manner which allows combining and/or comparing of the results or the survey sessions in generating a single report.

In some embodiments of the invention, the discussion relates at least partially to the provided questions. Alternatively or additionally, one or more of the questions are generated based on information from the discussion or from the answers to other questions.

In some embodiments of the invention, not all the respondents actively participate in the discussion, i.e., only answers and/or remarks of some of the respondents are provided to other respondents. Optionally, the number of respondents actively participating in the discussion is selected such that the amount of remarks provided to each respondent can be read and/or otherwise assimilated by the receiver.

Alternatively or additionally, at least some of the respondents receive only some of the answers and/or remarks of the other respondents. Optionally, the respondents are divided into sub-groups, each respondent receiving answers and remarks only from the members in his/her sub-group. Alternatively or additionally, each respondent receives remarks and/or answers from other respondents, without relation to whether the other respondents receive remarks from him.

In some embodiments of the invention, each respondent receives answers and remarks from a static group of respondents, for example selected at the beginning of the survey session. Alternatively, the rules governing the providing of the answers and remarks vary with the questions of the survey session and/or may be changed by the moderator. Optionally, the respondents are not directly notified whether their remarks and/or answers are provided to other respondents and/or to which other respondents.

Optionally, the rules governing the providing of the answers and remarks depend on the profiles of the respondents. For example, respondents known to be individualists and/or of a high income may be given more remarks to view and/or their remarks may be provided to a larger number of respondents. Further alternatively or additionally, the rules governing the providing of answers and remarks depend on the timing of the survey session in general or of a specific respondent. In some embodiments of the invention, the rules governing the providing of answers and remarks may depend on the remarks and answers, for example on the length and/or elaboration of the remarks, the time and/or speed in which they were typed by the respondent and/or whether specific keywords appear in the statements.

In some embodiments of the invention, a single moderator controls the questions provided to all the respondents. Optionally, if desired, one or more observers aid the moderator in viewing the answers and remarks of the respondents and direct suggestions to the moderator. Alternatively or additionally, a plurality of moderators manage the survey session. Optionally, the moderators are assigned priorities which determine whose instructions prevail when contradicting instructions are received.

Optionally, the same questions are provided to all the respondents. Alternatively, some of the questions are provided only to some of the respondents, for example questions directed only to respondents of a certain profile. Optionally, in order to save time, some questions may be provided only to a portion of the respondents, allowing the other respondents to perform a different task at the same time.

Optionally, the moderator may state for each question a number of respondents to which it is to be directed and the survey system distributes the question accordingly. In an exemplary embodiment of the invention, such distribution takes into account desired statistical tests to be met, desired confidence levels and/or bias controlling issues. In some embodiments of the invention, the moderator may further state the profile of the people to receive a question and/or the percentage of people of a specific profile to receive the question. In some embodiments of the invention, at least some of the questions include closed questions and/or other questions which allow for collection of quantitative data. Optionally, at least some of the questions are provided to all the respondents. In some embodiments of the invention, the moderator states as detailed as possible rules before beginning the survey session. During the survey session, the moderator may optionally change the rules, if desired.

The system of the present invention allows control of the number and identity of the people participating in a discussion, including conducting a plurality of discussions concurrently. The discussions are performed concurrently with the collection of data, allowing a moderator to use results from one of the quantitative data collection and the discussion in perfecting the other. The respondents in the discussions may be changed according to the progression of the discussion and/or the results of the quantitative data collection. The control of the discussions is optionally performed in a manner which keeps all the respondents active. Optionally, respondents not required for discussion listen to the discussions of others and/or participate in less important discussions.

An aspect of some embodiments of the invention relates to a computerized survey system in which the data displayed to respondents and/or the manner in which the data is displayed depends both on a profile of the respondent receiving the displayed data and on requirements on the number and/or profiles of respondents to receive the data.

In some embodiments of the invention, the displayed data is selected during a survey session in which the data is displayed, optionally based on data which changes during the survey session.

The displayed data may include questions from a moderator of the survey and/or automatically generated questions. Alternatively or additionally, the displayed data includes stimuli, answers of other respondents and/or remarks of other respondents.

In some embodiments of the invention, the respondent profile includes a social characteristic of the respondent, for example whether the respondent is a leader or a follower, the reading rate of the respondent and/or any other attribute of the behavior and/or attitude of the respondent in survey sessions. Alternatively or additionally, the respondent profile includes demographic and/or geographic characteristics, such as gender, age and residence area.

In some embodiments of the invention, the determination of the data displayed is performed responsive to actions and/or profiles of other respondents of the survey session.

Optionally, the survey system determines which data is provided to each respondent and/or the timing of the display of the data. The timing may include, for example, the order of display, the duration of the display and/or the time allowed for response (if at all). The determination of which data is received by the respondent may depend on the people from which information is received (e.g., people of a specific attribute, people who have different tastes, a group to which the people belong), or on the data itself (e.g., short remarks, disagreeing remarks). In some embodiments of the invention, the data provided is selected at least partially according to the type of the question asked, e.g., the importance of the question, the relevance of the question to the respondent.

In an exemplary embodiment of the invention, respondents identified as leaders are provided with answers of other respondents before answering a question, while a follower is provided with answers from others only after responding to questions.

The requirements on the number and/or profiles of respondents to receive the data optionally include requirements needed to ensure that the answers collected are statistically valid.

An aspect of some embodiments of the invention relates to adjusting the data provided to a respondent during a survey session and/or the manner in which the data is displayed, according to the timing of the progression of the survey, e.g., the time passing from the beginning of the survey and/or the time remaining until the end of the survey. Optionally, the adjustment is performed by a survey pace keeper, who may be human and/or automated.

Optionally, the remaining questions of the survey change according to the timing of the survey. Optionally, if the remaining time for answering the survey is limited, one or more questions are omitted. Alternatively or additionally, the number of possible answers is reduced from one or more questions. Further alternatively or additionally, open questions are converted to closed questions or vice versa according to the timing. Further alternatively or additionally, some or all of the questions are allotted specific time periods for responding, and the time allotted to answering one or more questions and/or the period in which the questions are provided are adjusted according to the timing of the survey. Further alternatively or additionally, the number of respondents to which questions are provided, is reduced.

In an exemplary embodiment of the invention, the time for which data is exposed to the respondents is adjusted according to the time remaining until the end of the survey session. Alternatively or additionally, the time assigned to providing answers to closed questions and/or to providing ratings to answers of other respondents, is reduced.

In some embodiments of the invention, the survey pace keeper is used with apparatus which provides the survey to a plurality of respondents substantially concurrently, and the change in the questions is performed in order to keep all the respondents in substantially the same pace, within a same time window or within a same discussion context. Alternatively or additionally, the change in the questions is performed in order to have the survey take up a predetermined amount of time without relation to the rate of answering of a specific respondent. This is optionally performed in a manner which does not impede the discussion interaction between the respondents.

In some embodiments of the invention, the survey pace keeper provides suggestions on changes in the data provided to the respondents, to the moderator. Alternatively or additionally, the survey pace keeper automatically changes the data provided to the respondents, with or without the knowledge of the moderator.

An aspect of some embodiments of the invention relates to apparatus for automatically generating questions for a survey based on answers and/or remarks from a plurality of respondents to previously provided questions. The apparatus optionally receives sets of questions and answers and accordingly generates suggested questions.

In some embodiments of the invention, the apparatus receives a question and a plurality of answers given to the question by respondents. The apparatus optionally selects from the received answers a plurality of answers to be included in a closed form of the question. The selected answers optionally include a predetermined number of most popular answers. Optionally, the apparatus also receives ratings given by the respondents to answers of other respondents. The closed question may include the answers having the highest ratings.

Alternatively or additionally, the generated questions comprise open questions, which relate to answers of a plurality of respondents to one or more previous questions. The generated question may, for example, probe the reason why a certain answer has a high or low popularity.

In some embodiments of the invention, the apparatus generates suggested questions for inclusion in the same survey session during which the answers are received. Alternatively or additionally, the questions are generated for a subsequent survey session.

An aspect of some embodiments of the invention relates to apparatus for conducting a survey in which a respondent asked a question is provided with answers given by other respondents to the question, delayed relative to the time in which the answers were received from the other respondents. The delay is optionally used in order to prevent biasing of the respondent receiving the answers from other respondents.

In some embodiments of the invention, the answers from the other respondents are displayed after the respondent answers the question. Optionally, the answers given by other respondents are collected from other respondents who are answering the survey substantially concurrently with the respondent to which the other answers are provided. In some embodiments of the invention, the answers provided to the respondent are selected based on one or more filtering parameters, for example, only short answers, are provided to the respondent. Alternatively or additionally, only answers disagreeing with the respondents answer and/or a certain percentage of disagreeing answers, are provided to the respondent.

In some embodiments of the invention, the answers from the other respondents are provided after at least a predetermined time from displaying the question, so as to allow the respondent a period of thought.

In some embodiments of the invention, one or more answers are shown to the respondent, before the respondent provides an answer to the question. Optionally, the timing of the display of the answers of other respondents and/or the specific answers provided to the respondent depend on a profile of the respondent.

An aspect of some embodiments of the invention relates to a system for conducting an interactive survey session by a single moderator who provides the questions, but not all respondents are provided the same question at the same time. During the interactive survey session, data is transferred between respondents, for example, the answers of at least some of the respondents are provided to others of the respondents.

Optionally, different respondents receive the questions of the survey at different rates, for example according to the profiles of the respondents. Alternatively or additionally, different respondents receive the same questions in different orders, for example, for anti-biasing.

In some embodiments of the invention, the respondents are divided into sub-groups which answer the questions in different orders.

In some embodiments of the invention, a respondent may refer back to old questions during the interactive survey session.

An aspect of some embodiments of the invention relates to a system for performing a survey, which includes a plurality of respondent stations and a plurality of control stations for controlling the data provided to the respondent stations. The plurality of control stations optionally may be used concurrently by different people. In some embodiments of the invention, the system includes a resolution unit, optionally included in one of the control stations, which determines what data is to be displayed when contradicting instructions are received from two different control stations. Optionally, the control stations have different priorities which determine the instruction that prevails in case of a contradiction. Alternatively or additionally, the contradicting instructions are provided to a third control station, which serves as an arbitrator. In some embodiments of the invention, the control of the data includes determining the questions displayed to the respondents and/or the timing of the display.

In some embodiments of the invention, each of the respondent stations manages a buffer of data to be displayed. Data received by a respondent station from a control station is placed in the buffer and is displayed according to the order in which the data was received by the respondent station. Alternatively or additionally, one or more of the control stations has a higher priority and data from that control station is displayed before data from other stations.

An aspect of some embodiments of the invention relates to a survey system which provides at least some respondents with questions that they are not permitted to answer, but other respondents of the survey are allowed to answer. The display may be used to allow the respondents to know what the other respondents are relating to during a discussion between respondents.

An aspect of some embodiments of the invention relates to a survey session which results in providing quantitative data on answers to both first and second questions, the second question relating to the reasons of the quantitative data on the answers of the first question. Optionally, the first and second questions are provided to the same respondents. Alternatively, the first and second questions are provided to partially overlapping groups of respondents. Optionally, the second question comprises an open question. Alternatively or additionally, the second question comprises a request to rank one or more reasons. The reasons may be, for example, generated by a moderator or may be collected from respondents by an open question.

An aspect of some embodiments of the invention relates to a system for performing surveys, which monitors and/or analyses results substantially in real-time, with respect to goals of the survey. In an exemplary embodiment of the invention, if the results do not fit a goal, the system alerts a moderator that the goal was not achieved. In an exemplary embodiment of the invention, the goal is a threshold goal, for example that a confidence level is above a certain value or that at least a certain number of different answers are received. In an exemplary embodiment of the invention, the goal includes finding a single concept which has a distinctly better grade from a plurality of concepts. In some embodiments of the invention, the system suggests one or more questions to be used to probe for the reasons why the goal was not achieved. Alternatively or additionally, the system suggests or adds more respondents, if a statistical goal is not met. Further alternatively or additionally, the system suggests questions and/or stimuli to be used to achieve the goal.

An aspect of some embodiments of the invention relates to using ratings from one or more respondents to assist text mining. In an exemplary embodiment of the invention, a system is provided for identifying similar statements, for example equivalent answers to a question. The system optionally receives a plurality of statements and provides the statements to a plurality of respondents for rating. For each pair of statements, a rating similarity score is defined based on the similarity of the ratings of the statements. In addition, the statements are assigned a text similarity score based on text mining methods. A total similarity score is optionally provided as a function of the text similarity score and the rating similarity score.

An aspect of some embodiments of the invention, relates to survey design. In an exemplary embodiment of the invention, a survey is designed to include focus groups that provide statistically valid data, by setting goals which are to be met, for example qualitative and/or quantitative goals. Optionally, the design includes defining one or more questions, sets of questions, question templates, contexts, types of discussion, groups, sub-groups, data exposure rules, stimuli, questions and/or stimuli orders and/or slack in a survey. Alternatively or additionally, the design includes defining a series of survey sessions which together cooperate to provide the desired information. In an exemplary embodiment of the invention, the design takes into account a large number of respondents, for example, 40, 60, 100, 200, 500, 1000 or more.

There is therefore provided in accordance with some embodiments of the invention, a method of conducting a survey, comprising providing a plurality of questions to respondents, at least some questions being provided to a plurality of the respondents, collecting answers to the questions from the respondents, transferring at least some of the answers to respondents other than those who generated the answers, collecting responses to the transferred answers, at least some of the responses being qualitative, and providing a statistical report which is at least partially based on qualitative responses collected from the respondents.

Optionally, collecting the responses comprises collecting from fewer than all the respondents receiving the questions. Optionally, the plurality of respondents comprise at least 30 respondents. Optionally, collecting responses to the transferred answers comprises collecting remarks. Optionally, the method includes using the statistical report in providing one or more of the questions. Optionally, providing the statistical report comprises generating the report automatically. Optionally, providing the questions, collecting the answers and responses and transferring the answers are performed during a time bound survey session. Optionally, the time bound survey session has a duration of less than three hours. Optionally, at least one of the questions is provided after transferring at least some of the answers to respondents other than those who generated the answers. Optionally, substantially all the questions are provided to substantially all the respondents.

Optionally, at least one of the questions is provided to fewer than all the respondents. Optionally, the respondents are divided into sub-groups and wherein transferring the answers comprises transferring each answer to respondents in the same sub-group as the respondent generating the answer. Optionally, at least one of the provided questions is generated responsive to the collected responses. Optionally, at least one of the provided questions is generated responsive to statistics on the answers collected from a plurality of respondents. Optionally, the at least one question is generated automatically. Optionally, transferring the answers comprises transferring answers from at least one of the respondents to a group of respondents which changes during the survey for different answers of the respondents. Optionally, the group of respondents receiving the answers changes at least partially according to the contents of the answers. Optionally, the group of respondents receiving the responses changes at least partially according to a question with which the remark is associated.

There is further provided in accordance with some embodiments of the invention, a system for conducting a survey, comprising a plurality of respondent stations adapted to collect statements from respective respondents, at least one presentation station adapted to provide questions to the respondent stations for display to the respondents, a server adapted to provide statements collected by at least one first respondent station to one or more second respondent stations, at least one of the collected statements being generated responsive to a statement provided by the server, and a report unit adapted to provide a report of quantitative data summarizing answers provided by the respondents to provided questions.

Optionally, the respondent stations are adapted to collect each statement with relation to a specific provided question or statement. Optionally, the server and at least one presentation station are implemented by a single computer. Optionally, the at least one presentation station is adapted to collect answers to the questions. Optionally, at least some of the questions include closed questions.

There is further provided in accordance with some embodiments of the invention, a method of conducting a survey with a plurality of respondents, comprising determining a profile of at least one respondent, receiving data to be distributed to at least some of the respondents, providing at least one requirement on the number or profiles of the respondents to receive the data; and distributing the data to at least some of the respondents in a manner selected responsive to the profile and the at least one requirement.

Optionally, receiving the data comprises receiving a question. Optionally, receiving the data comprises receiving a remark or answer from one of the respondents. Optionally, the method includes receiving responses from the respondents and wherein receiving the data comprises receiving data generated responsive to the responses from the respondents. Optionally, determining the profile comprises determining a demographic or geographic characteristic of the respondent. Optionally, determining the profile comprises determining a social characteristic of the respondent. Optionally, providing the at least one requirement comprises providing a requirement on the number of respondents to receive the data.

Optionally, providing the at least one requirement comprises providing a requirement on the percentage of respondents having a specific characteristic, to receive the data. Optionally, distributing the data to at least some of the respondents comprises distributing to respondents selected responsive to the profile and the at least one requirement. Optionally, distributing the data to at least some of the respondents comprises distributing to respondents selected responsive to the generator of the distributed data. Optionally, distributing the data to at least some of the respondents comprises distributing to respondents selected responsive to the contents of the distributed data. Optionally, distributing the data to at least some of the respondents comprises distributing the data with a timing selected responsive to the profile and the at least one requirement. Optionally, distributing the data with a timing selected responsive to the profile and the at least one requirement comprises distributing answers to a question to at least some of the respondents, after they provide answers to the question.

There is further provided in accordance with some embodiments of the invention, a method of conducting a survey, comprising receiving data on the timing of the progression of the survey; and displaying data of the survey to a respondent in a manner selected responsive to the received timing data.

Optionally, the received data on the timing of the progression of the survey comprises receiving data on the time passing from the beginning of the survey or remaining until the end of the survey. Optionally, displaying data of the survey to the respondents in a manner selected responsive to the received timing data comprises selecting the wording of one or more questions of the survey responsive to the timing data. Optionally, selecting the wording of one or more questions of the survey comprises selecting whether to display a closed, open or half closed question. Optionally, the method includes preparing a roster of questions to be asked during the survey and wherein displaying data of the survey to the respondents in a manner selected responsive to the received timing data comprises deterring from the roster of questions responsive to the received timing data. Optionally, deterring from the roster of questions comprises skipping at least one question in the roster. Optionally, deterring from the roster of questions comprises reducing the number of answers in at least one question of the roster.

Optionally, displaying data of the survey to the respondents in a manner selected responsive to the received timing data comprises setting a time for responding to the displayed data responsive to the timing data. Optionally, the survey has a plurality of concurrently connected respondents and wherein displaying data of the survey to a respondent in a manner selected responsive to the received timing data comprises displaying such that all the respondents are within a same context of the survey.

There is further provided in accordance with some embodiments of the invention, a survey system, comprising a question provider adapted to provide a question to a plurality of respondents, an answer input unit adapted to receive answers from the respondents and a processor adapted to generate at least one question, responsive to the answers received from the respondents.

Optionally, the processor is adapted to select from a plurality of answers given to an open question, several answers to be used in a closed question version of the open question. Optionally, the answer input unit is adapted to receive from the respondents ratings of the answers, and wherein the processor uses the ratings in generating the at least one question. Optionally, the processor is adapted to generate open questions. Optionally, the processor is adapted to generate an open question which asks for the reason of the statistical distribution of answers to one or more questions. Optionally, the question provider is adapted to provide at least one question generated by the processor during a same survey session in which the answers used in generating the question were received.

There is further provided in accordance with some embodiments of the invention, a method of conducting a survey, comprising providing a question to a plurality of respondents, receiving answers from at least some of the respondents; and providing a first respondent with an answer received from at least one second respondent, delayed relative to the time the answer was received.

Optionally, providing the answer received from the at least one second respondent comprises providing the answer from the second respondent only after receiving an answer from the first respondent, although the answer from the second respondent was received before the answer from the first respondent. Optionally, providing the first respondent with an answer from at least one second respondent comprises providing the first respondent with a plurality of answers. Optionally, providing the first respondent with an answer from at least one second respondent comprises providing the first respondent with fewer than all the answers received from other respondents. Optionally, providing the first respondent with an answer from at least one second respondent comprises providing one or more answers which fit one or more filtering requirements.

There is further provided in accordance with some embodiments of the invention, a method of conducting an interactive survey session, comprising providing at least one question to a plurality of respondents during the session, conducting a discussion between at least some of the plurality of respondents during the session, and providing at least two of the plurality of respondents with different questions, substantially concurrently during the session.

Optionally, conducting the discussion comprises passing at least one statement generated by one of the respondents to substantially all the other respondents. Optionally, providing at least two of the respondents with different questions comprises providing a first respondent with a question not provided to a second respondent throughout the session. Optionally, providing at least two of the respondents with different questions comprises providing a first respondent with a question provided to a second respondent earlier during the session.

There is further provided in accordance with some embodiments of the invention, a survey system, comprising a plurality of respondent stations adapted to provide questions to respondents and at least two control stations adapted to control the provision of data by the respondent stations.

Optionally, the system includes an arbitration unit adapted to resolve contradicting instructions received from the at least two control units. Optionally, a first control station controls a first group of respondent stations and a second control station controls a second group of respondent stations different from the first group. Optionally, the first control station controls at least one of the respondent stations of the first group to display data received from a respondent station of the second group. Optionally, the at least two control stations control the data provided to the respondent stations. Optionally, the at least two control stations control the timing of the display of the respondent stations.

There is further provided in accordance with some embodiments of the invention, a survey system, comprising a display unit adapted to provide questions to a respondent, and an input interface adapted to receive answers to the questions from the respondent, the input interface does not accept an answer for at least one of the displayed questions. Optionally, the display unit is adapted to provide the respondent with answers to the question for which the input interface does not accept answers. Optionally, the input interface is adapted to accept responses to the question for which the input interface does not accept answers, from the respondent.

There is further provided in accordance with some embodiments of the invention, a method of conducting an interactive survey session, comprising providing, during a survey session, a first question to a first group of a plurality of respondents, collecting answers to the first question, statistically analyzing the collected answers to the first question, providing, during the survey session, a second question on the reasons to the statistical distribution of the collected answers to the first question, to a plurality of respondents, collecting answers to the second question, and providing a statistical tabulation of the answers to the second question.

Optionally, the second question comprises an open question. Optionally, the second question comprises a request to rate one or more given explanations to the statistics of answers of the first question.

There is further provided in accordance with some embodiments of the invention, a method of conducting a survey, comprising setting a survey goal, providing a plurality of questions to respondents, collecting answers to the questions from the respondents, transferring at least some of the answers to respondents other than those who generated the answers, comparing a current state of the survey to the goal, and controlling the transferring of the answers responsive to the comparison.

Optionally, controlling the transferring of the answers comprises determining a number of respondents to receive an answer. Optionally, transferring at least some of the answers comprises transferring to fewer than all the respondents.

There is further provided in accordance with some embodiments of the invention, a survey system, comprising a memory for storing a survey goal, a data provider for providing data to respondents, an input unit adapted to receive input from the respondents, responsive to the provided data, and a processor adapted to analyze the input from the respondents in order to determine a survey state, to compare the survey state to the survey goal and to control the providing of data to the respondents responsive to the comparison.

Optionally, the data provider is adapted to provide questions to the respondents. Optionally, the processor is adapted to control the number of questions provided to the respondents responsive to the comparison. Optionally, the processor is adapted to determine when to terminate the survey responsive to the comparison. Optionally, the data provider is adapted to transfer input received from respondents to other respondents that did not provide the input. Optionally, the data provider is adapted to transfer at least some of the input received from respondents to fewer than all the other respondents that did not provide the input. Optionally, the processor is adapted to control the number or identity of respondents to which the input is transferred, responsive to the comparison.

Optionally, the input unit is adapted to receive from the respondents answers to questions. Optionally, the processor is adapted to determine a binary value as to whether the goal was achieved responsive to the comparison. Optionally, the processor is adapted to determine an extent to which the survey state is distanced from the goal responsive to the comparison. Optionally, the input unit is adapted to receive remarks and/or answers from the respondents.

### BRIEF DESCRIPTION OF THE FIGURES

Particular, non-limiting embodiments of the invention will be described with reference to the following description of embodiments, in conjunction with the figures, in which:

FIG. 1 is a generalized block diagram of a survey system, in accordance with an embodiment of the invention; and

FIG. 2 is a flowchart of a survey session, in accordance with an embodiment of the present invention.

### DETAILED DESCRIPTION OF EXEMPLARY EMBODIMENTS

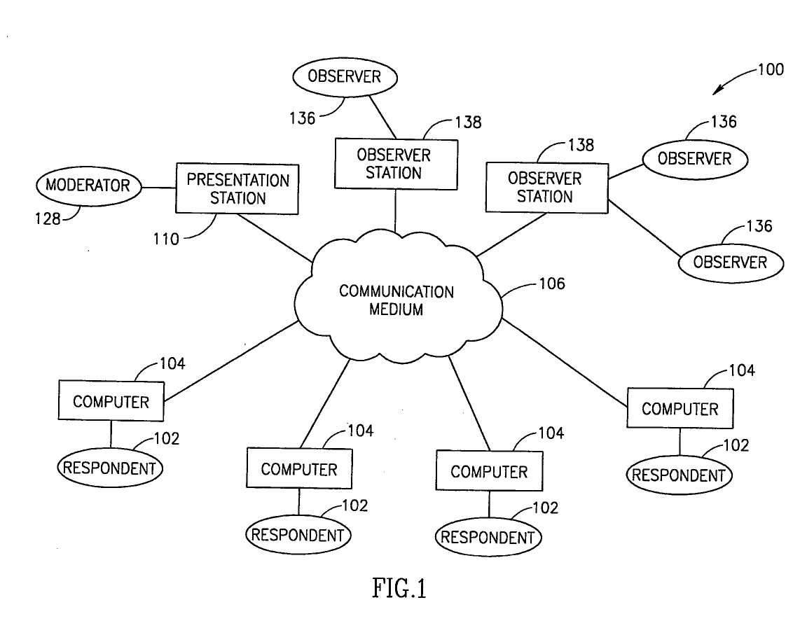

FIG. 1 is a generalized block diagram of an on-line survey system 100, in accordance with an embodiment of the invention. A plurality of respondents 102 connect, for example using computers 104, to a presentation station 110, which is used to manage a survey. In an exemplary embodiment of the invention, computers 104 connect to presentation station 110 through a communications medium 106 (e.g., an Internet).

Presentation station 110 optionally provides questions and stimuli to respondents 102 via computers 104 and receives responses from respondents 102. Alternatively or additionally, stimuli may be provided to the respondents using other methods, such as mail and cable TV. Presentation station 110 optionally governs the display format on computers 104 and the method of allowing input of data from respondents 102. Optionally, each computer 104 operates a web browser which runs file received from presentation station 110. Alternatively or additionally, a dedicated software on computers 104 is controlled by presentation station 110.

Alternatively or additionally to computers 104, respondents 102 and/or moderator 128 may interact with the survey using other communication devices, such as cellular telephones, interactive televisions, and/or personal data assistants (PDAs), such as Palm Pilots or Visors.

In some embodiments of the invention, presentation station 110 operates survey sessions automatically based on instructions preprogrammed into presentation station 110, for example by a researcher. Alternatively or additionally, a moderator 128 optionally controls presentation station 110 during survey sessions, for example by stating questions and stimuli to be provided to respondents 102 and/or controlling to which of the respondents the questions are directed. The stimuli provided during the survey session is optionally prepared in advance before the survey session. Alternatively or additionally, moderator 128 may prepare stimuli during the survey session. In some embodiments of the invention, presentation station 110 displays responses received from respondents 102 to moderator 128. Optionally, presentation station 110 transfers responses from respondents 102 to other respondents as described below. The transfer of responses is optionally performed under general instructions of moderator 128 during survey sessions and/or based on previously programmed instructions. The general transfer instructions may include, for example, a statement on the number of respondents to which specific responses are to be transferred and/or the identities of the respondents to which responses from a specific respondent are to be transferred.

In some embodiments of the invention, one or more observers 136, using observer stations 138, view the flow of a survey session. Optionally, observers 136 may send suggestions regarding the flow of the session to moderator 128. Alternatively or additionally, observers 136 may interrupt in one or more parameters of the control of the survey session and/or may override moderator 128. Observer 136 may optionally be a client interested in viewing the survey session in real-time. Alternatively or additionally, observer 136 is a moderator assistant who helps the moderator by summarizing data generated by the respondents in the survey session. In an exemplary embodiment of the invention, the moderator's task is limited to technical management of the survey session, while the data review is performed only by the observers.

In some embodiments of the invention, observers 136 control their observer stations 138, determining what data to view and how the data is presented. Alternatively, observers 136 are presented the same data as presented to moderator 128 or are presented with other data whose contents is determined by moderator 128, from presentation station 110. Further alternatively or additionally, observer stations 138 may be controlled by moderator 128 or observer 136. Observer stations 138 may be computers or any other communication apparatus, such as mentioned above. In an exemplary embodiment of the invention, one or more observer stations 138 comprise cellular phones on which respondent remarks are sounded and/or displayed. Suggestions to moderator 128 may be transmitted in SMS messages to presentation station 110.

In some embodiments of the invention, system 100 allows a single moderator to manage a survey session of many respondents, e.g., hundreds or even thousands, in which the respondents conduct discussions related to the survey.

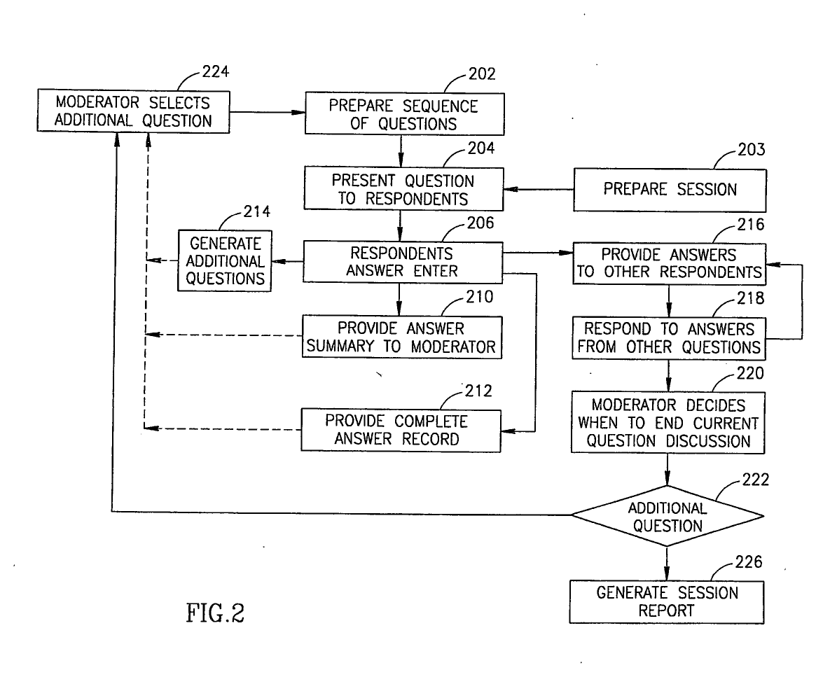

Reference is also made to FIG. 2, which is a general flowchart of a survey session, in accordance with an exemplary embodiment of the present invention. It is noted, however, that the survey may have other structures, for example a more free discussion with fewer questions. Before the session begins, a researcher optionally prepares (202) a roster of questions which are to be provided to respondents 102. The questions may be open questions, half open questions and/or closed questions. The questions may be displayed to the respondents and/or sounded to the respondents. In some embodiments of the invention, one or more of the questions may be accompanied by images, video clips, audio files and/or any other stimuli. The term question refers herein also to statements and other stimuli which arouse responses, even if they are not linguistically defined as questions.

In some embodiments of the invention, the roster may include optional questions and/or display modes which may be used by moderator 128 during the survey session. Optionally, the roster may be built in the form of a flowchart with decision points along the path. During the survey session, moderator 128 decides which path to use and accordingly the survey proceeds. Alternatively or additionally, at one or more decision points, presentation station 110 selects the path taken according to one or more parameters of the survey session. The roster may also include other parameters of the session, such as the stimuli to be provided along the survey session and/or the numbers and/or identities of the respondents of each question.

In some embodiments of the invention, the questions of the roster are organized in context groups, the questions of each group relating to a respective context, for example different concepts and/or ideas, such as product packages and/or names. Optionally, along with each question, respondents 102 are displayed a stimuli relating to the context.

In an exemplary embodiment of the invention, each question is assigned an identification number (ID) (and/or name) which allows easy tracking of the questions, for example in comparing to answers of same questions in other sessions. Optionally, the question IDs include a complex structure which identifies the context of the question and the type of the question. This complex structure allows easy comparison of same questions relating to different concepts.

In some embodiments of the invention, moderator 128 and/or a researcher prepares (203) the session, for example by recruiting people to participate in the survey session, setting the time of the session and making sure all respondents have required hardware and/or software. During the survey session, presentation station 110, automatically and/or under instructions of moderator 128, presents (204) the respondents 102 with questions from the roster and/or with questions generated in real time. Respondents 102 enter (206) answers to the questions to their computers 104. These answers are transmitted to presentation station 110, which processes the responses and provides (210) an answer summary to moderator 128. Alternatively or additionally, presentation station 110 provides (212) a complete record of the answers to moderator 128 and/or to observers 136. In some embodiments of the invention, observers 136 provide important excerpts and/or suggestions to moderator 128. Further alternatively or additionally, a complete answer record is provided for a selected group of important questions and/or from a selected sub-group of respondents 102 whose answers are expected to be of particular on-line interest.

In some embodiments of the invention, presentation station 110 generates (214) additional questions responsive to the received responses. The generated additional questions are optionally provided to moderator 128 who may determine if and when to provide the generated question to the respondents. Alternatively or additionally, generated questions may be provided automatically by station 110 based on previously configured rules and/or decisions made during the survey session.

In some embodiments of the invention, answers to open questions and/or half open questions received from respondents 102 are provided (216) to other respondents for viewing, in order to receive rating and/or arouse a discussion between the respondents. The respondents receiving answers from other respondents may optionally use these statements in preparing their answers (206) to the same question and/or may respond (218) to these answers with discussion remarks. The discussion remarks are optionally provided to other respondents for review and discussion. In some embodiments of the invention, answers from other respondents may be presented as questions to which the other respondents may provide ratings (e.g., agree/disagree, between 1-10) and/or statement answers.

The interaction between the respondents may be at different levels, for example based on a moderator selection. The selection may be based, for example, on the amount of ideas it is desired to get from the respondents, versus the time constraints of the survey session. Optionally, the interaction between respondents may include rating of answers of other respondents, providing remarks to answers of other respondents, one sided transfer of remarks, open discussion (direct or through the moderator) and/or allowing transfer of a limited number of remarks.

Alternatively to presentation station 110 collecting answers and transmitting the answers to computers 104, each computer 104 is instructed to which other computers to transmit its answers. Alternatively or additionally, a router and/or server connected before presentation station 110 handles the answer transmission, so as to reduce the load on presentation station 110. The server may optionally perform other tasks described hereinbelow as being performed by presentation station 110, for example data buffering.

Moderator 128 optionally follows the discussion and decides (220) when to end the period allotted to answering the current question. If (222) an additional question is to be provided, moderator 128 selects (224) an additional question to be provided to respondents 102. At the end of the survey session, presentation station 110 optionally generates (226) a session report.

Computers 104 are optionally adapted to keep respondents 102 busy to a sufficient extent. Optionally, presentation station 110 provides each respondent 102 with a sufficient amount of data, such that the respondent is not bored. In some embodiments of the invention, data is provided to each respondent 102 at a predetermined rate, for example a fixed number of characters or statements per minute. The data may include, for example, questions, answers from other respondents and/or remarks.

Referring in more detail to preparing (202) the roster of questions, the roster of questions may be generated for a single subject or for a plurality of different subjects. In some embodiments of the invention, a single set of questions is prepared for a plurality of sessions. Presentation station 110 is optionally adapted to shuffle the questions in the roster, so that different question orders are used for different sessions, to prevent bias. In some embodiments of the invention, the shuffling is performed randomly for each session. Alternatively, a sequence of sessions is pre-planned with each session having a different arrangement of questions. Further alternatively or additionally, the shuffling is performed based on results of previous sessions. Optionally, the set of questions may be adjusted based on discussions during previous sessions.

In some embodiments of the invention, the results of a previous survey session are used in generating questions of the roster. For example, an open answer provided in a previous session may be converted into a closed question or a half closed question based on answers received in the previous session.

Optionally, one or more open questions in the roster, prepared before the session, are associated with possible answers, for example answers from previous sessions. In some embodiments of the invention, if a sufficient number of answers are not received from the respondents during the survey session, the answers from the roster are provided to the respondents for rating as if they were received from respondents of the current session.

In some embodiments of the invention, the roster of questions includes for each question, a period of time during which the question is to be displayed and/or a stimuli sequence to be shown before and/or along with the question. A time for receiving answers may also be stated for some or all of the questions.

In some embodiments of the invention, the roster of questions includes more questions than are planned to be used to allow moderator 128 to select questions according to the development of the session. Optionally, the roster is organized in the form of a tree with different branches according to the direction the discussion follows.

It is noted, however, that in many cases it is hard to predict which questions will be relevant, before the discussion begins. Therefore, in some embodiments of the invention, moderator 128 is able to use questions not in the roster, modify questions from the roster and/or not use questions although they are included in the roster. Optionally, the roster includes question templates which allow fast generation of questions by the moderator during the survey session. An exemplary template may have the form “why do members of ‘group 1’ prefer this product in comparison to members of ‘group 2’?”, or the form “which of the following products ‘product 1’, ‘product 2’ . . . ‘product n’ would you prefer to buy?”.

Referring in more detail to preparing (203) the survey session, in some embodiments of the invention, the selection of the respondents is performed according to statistical parameters, so that the respondents truly represent a population of interest. Optionally, respondents are offered compensation for participating in the survey session. In some embodiments of the invention, the extent of the compensation varies with the correlation of the respondent to a desired portfolio and/or with the extent to which the respondent cooperates, answers questions and/or actually assists statistically (e.g., adds to the confidence of the results, reduces variance).

The number of respondents is optionally relatively large (e.g., above 50, 100, 300, 700 or more) in order to provide statistical authenticity to the survey results. Optionally, in providing the answers between respondents, each respondent receives a limited number of answers, so that respondents are not flooded with information, as discussed below.

In some embodiments of the invention, when too many people come to a survey and/or people not fitting the survey ask to participate, these people are rejected from participating in the survey. Alternatively, these people are given a different survey, for example one which is not required, in order not to discourage them from coming again to surveys or to keep them in standby in case they are needed during the survey session. In some embodiments of the invention, rather than answering a totally unrelated survey, the excess respondents may be used as a control group or for other less important tasks.

Referring in more detail to respondents 102 entering (206) answers to the questions, in some embodiments of the invention, the answers and remarks are entered in text, for example using a keyboard. Alternatively or additionally, respondents 102 may speak out their answers and computer 104 converts the answers into text. Alternatively or additionally, computer 104 transmits voice files with the respondents answers to presentation station 110, where the answers are converted into text, for transfer to other respondents and display to moderator 128. Optionally, moderator 128 may request to hear one or more respondent remarks, for example after the survey session is completed. In some embodiments of the invention, computer 104 is attached to video apparatus (not shown) which is used to collect additional information on the respondent's attitude toward the discussed subjects. Further alternatively or additionally, answers may be provided as drawings and/or other non-text visual input.

The answers provided by the respondents may be of one or more types, including, for example, selecting one or more answers of closed questions, Providing a remark regarding the selection, providing a rating of a statement, providing a word and/or providing a text statement. Optionally, the questions provided by the moderator define which of the answer methods may be used.

In some embodiments of the invention, a respondent may provide answers to old questions that he/she did not answer earlier, may provide additional answers to old questions and/or may replace old answers. Optionally, when a respondent refers to an old question (e.g., by scrolling or using a back button), the stimuli associated with the old question are provided again to the respondent. The answer to the old question is optionally provided to presentation station 110 along with an indication on the information provided to the respondent until the answer was provided. This allows presentation station 110 to indicate a bias factor for the answer.

In some embodiments of the invention, while a respondent is referring to an old question of a different context, the respondent is not provided with questions and/or remarks from other respondents. After returning to the current context, the respondent is provided with the questions and remarks that he/she did not receive. Alternatively, the respondent is provided with fewer questions, in order to allow the respondent to catch up with the other respondents. Alternatively, the respondent is allowed to continue participating in his current discussion while referring to an old question. In some embodiments of the invention, when a respondent relates to an old question of a context which is currently being discussed by a different group of respondents, the respondent is joined into this group instead of, or in addition to, his current group.

Optionally, the moderator may control the ability of respondents to refer back to old questions. The control is optionally performed through presentation station 110, by stating general rules and/or specific instructions (e.g., relating to a specific respondent). The moderator can control, for example, for each respondent and/or for each question, how much back the respondent may refer, if at all. For example, after a certain amount of data is viewed, respondents may be prevented from referring back to some questions. Alternatively or additionally, respondents who are slow in answering questions may be prevented from referring back to old questions, so that they do not waste time on these questions instead of answering more questions. In some embodiments of the invention, when important questions are displayed, respondents may not refer to other questions.

Referring in more detail to providing (210) an answer summary to the moderator, in some embodiments of the invention, the summary states, for closed questions, the percentage of respondents agreeing with each possible answer. In some embodiments of the invention, each respondent is assigned a weight which is given to answers provided by the respondent, and the summary is adjusted according to the weights. Thus it is possible to correct for under-representation of certain groups (e.g., demographic and/or geographic groups). In some embodiments of the invention, different weights are given to responses given by respondents who saw responses of other respondents before answering.

Optionally, each question is marked with the number of respondents to which the question was provided, a group profile of the respondents (e.g., 60% men, 40% women and/or sub-groups to which they belong) and/or the number of respondents providing answers to the question.

In some embodiments of the invention, for questions whose answers range on a scale, an average or other score value is used to represent the answers given by the respondents.

For open questions, the summary optionally groups similar answers together and states for each answer the percentage of respondents providing the answer. In some embodiments of the invention, text mining methods are used to analyze the answers. For example, dominant words are extracted from the answers by presentation station 110 and the number of answers including each dominant word are included in the summary. Moderator 128 may optionally request to view the answers including a specific dominant word.

Optionally, the summary differentiates between answers given by respondents having different contexts. For example, the answers of respondents seeing first and second products may be displayed separately from answers of respondents seeing second and third products.

In some embodiments of the invention, text mining methods are used to identify positive and/or negative words. Answers including negative paradigms are optionally grouped together. Alternatively or additionally, the answers are displayed with negative words marked.

As described below, in some embodiments of the invention, the respondents rate their agreement with answers of other respondents. Optionally, these ratings are used together with text mining in combining similar answers. In some embodiments of the invention, answers are combined as being similar if they have a similar rating and similar text mining results. Alternatively or additionally, answers are considered opposites if they have similar text mining results except for negation words and they have substantially opposite rating results.

In some embodiments of the invention, the ratings of the answers of open questions are used in combining the results of the results of the closed questions and of the open questions.

Optionally, answers given by respondents who saw other responses before answering are marked accordingly to prevent bias. Alternatively or additionally, the respondents are divided into different groups viewing controlled different stimuli, so as to control the bias and allow separate statistical analysis of different bias groups.

In some embodiments of the invention, summary includes a comparison of results received for different tested concepts. Optionally, the comparison is shown in the form of a table or graph which shows a comparison of the results of same questions relating to the different concepts. Alternatively or additionally, for open questions, the summary points out similar answers received for different concepts and optionally the number of times the similar answers appear for each concept.

The summary may include an analysis of the results. In some embodiments of the invention, the results in the summary are analyzed to determine whether they achieve a predetermined goal, for example finding three best possibilities out of ten, or finding a best choice with at least a predetermined margin. The summary optionally states whether the goal was reached and/or suggests questions to be used to reach the goals. It is noted that by having a large number of respondents and using the tools provided by the present invention, knowledge of the goals and how close they are to being achieved may be used during the survey session in asking additional questions and/or utilizing additional respondents, so as to achieve the goals. Alternatively or additionally, when the goals are reached, the survey may be terminated before utilizing all the questions prepared in advance, so as not to waste time on questions which are not needed.

In some embodiments of the invention, the summary includes results of a variance result analysis which searches for inter-related parameters.

In some embodiments of the invention, in generating the summary, the answers are reviewed to weed out erroneous answers. The review is optionally performed automatically by station 110 and/or manually by human moderator assistants to which presentation station 110 displays all or suspicious answers. For example, answers from a respondent who provides contradicting answers may be weeded out. Alternatively or additionally, the answers of a respondent who did not answer critical questions, did not answer a large number of questions and/or stated that he/she is not familiar with a discussed product, are weeded out. Alternatively to weeding out all the answers of a respondent, only the answers which are clearly contradicting or are clearly meaningless are weeded out. Further alternatively or additionally, lower weight is provided in the summary to answers from a respondent providing contradicting answers. In some embodiments of the invention, the roster includes duplicate questions (possibly using different wording) directed to determine the consistency of respondents, as is known in the art.

Alternatively or additionally, in generating the summary, the answers are reviewed to weed out obscene statements. For example, the respondents may be provided with rating buttons to be used for rating remarks as inappropriate for display. Alternatively or additionally, the answers are compared to a dictionary of dirty words and answers including inappropriate words are deleted or are provided to the moderator (or a moderator assistant) for examination before they are provided to other respondents.

In some embodiments of the invention, obscene statements are not forwarded to other respondents. Alternatively or additionally, answers from respondents providing obscene statements are not provided to other respondents. In some embodiments of the invention, respondents providing obscene statements, having statements which tend to be weeded out and/or having a contradicting response pattern, are blocked out of the survey system.

In some embodiments of the invention, each respondent has on his/her respective computer 104, controls for rating the answers and/or remarks of other respondents. The ratings optionally relate to agreement with the statement. Alternatively or additionally, the ratings relate to clarity, preciseness, importance and/or relevance of the answers and/or remarks.

In some embodiments of the invention, the display of the answers to the moderator is affected by the ratings given to the answers. For example, the summary may highlight or enlarge those statements which have high and/or low levels of agreement and/or those remarks which are rated as clear. Alternatively or additionally, only answers of interest, e.g., receiving high levels of agreement and/or disagreement, are displayed to the moderator, so as not to flood the moderator with data.

Optionally, when the survey session is part of a set of sessions of a single research (carried out in series and/or in parallel), the summary is displayed along with a comparison to previous sessions of the research. Alternatively or additionally, an accumulative summary is displayed. Optionally, the data of each session is displayed along with demographic information on the respondents of the session. Alternatively or additionally, the data of each session is displayed along with context information on the data the respondents saw. In some embodiments of the invention, moderator 128 may request to see the results given by respondents having one or more characteristics, e.g., age, gender, income. In some embodiments of the invention, the summary data of each session states bias related parameters, such as the data displayed to the respondents before answering the question.

In some embodiments of the invention, a summary of discussions between respondents 102 is also provided to moderator 128. Optionally, the summary includes only remarks, which are expected to be of interest. In some embodiments of the invention, the summary includes only short remarks, long remarks, or remarks which are otherwise expected to be of interest. Alternatively or additionally, the summary includes only remarks from specific respondents, for example leader respondents and/or respondents who are expected to provide unique remarks. Optionally, the summary is created by presentation station 110 using text mining methods, based on ratings provided by other respondents and/or using a combination thereof.

In some embodiments of the invention, the remarks are displayed chronologically according to the time the statements were entered by the respondents, as a sequence of text items. Alternatively or additionally, the moderator's display is divided into a plurality of frames (or windows, columns or other display division units) corresponding to different discussion groups and/or sub-groups of respondents. In each frame, the remarks and answers of a different group are displayed. Further alternatively or additionally, the moderator's display is divided into a plurality of frames, each of which displays data relating to a different context. In an exemplary embodiment of the invention, the display includes a first frame which shows a summary of all the data and a second from which shows details of a specific context, group, question or respondent of interest.

In some embodiments of the invention, the moderator's display shows the questions provided to the respondents. Upon clicking on a question, the display shows the answers given to the question, or a summary of the answers. Upon clicking on an answer, the display optionally shows the remarks given to the answer (optionally in a tree or chain format), and so on. Alternatively to starting the display with questions, the display starts with showing concepts. In some embodiments of the invention, the moderator may control the organization of the display, for example sorting and/or filtering questions and/or answers according to timing, type and/or context. The sorting and filtering may be performed using various keys, such as the text of the statements, their ratings, the extent of additional discussion they spawned and/or the respondent names.

In some embodiments of the invention, answers and/or remarks are displayed along with the ratings they received. Alternatively, only the last remark in a chain of remarks is displayed with a rating.

In some embodiments of the invention, before the survey session, a set of goals is defined for the survey, for example in the form of a table. For example, the goals may include finding a concept with a maximal cost and purchase level, and finding out which factors affect purchaser's decisions. The summary optionally continuously and/or periodically updates the table of goals. The moderator optionally keeps track of the goals in determining the track of the survey and when to terminate the session.

In some embodiments of the invention, the goals are defined in statistical terms, for example requiring a confidence level of 90 or 95% and with an error of ±5 or 10%. In some cases, lower confidence levels, such as 70%, 75% or 80% may be sufficient. Another example of a definition is that of a statistical test, for example a “t” or “f” test, which a survey result should satisfy to be acceptable. Another example is whether a small population sample is required or a large one. Another example is to reconstruct a type of a distribution of a variable (e.g., Gaussian or bi-modal) and/or other parameters, such as variance.

Example of statistical goals for qualitative feedback, include, for example, for an open-ended question, a probability of over X % (e.g., 70%, 80%, 90%) that the Y answers selected cover the entire spectrum or at least Z % (e.g., 70%, 80%, 90%) of a spectrum. An example of a goal for a specific answer, that the answer represents the entire (or part, e.g., 30%, 50%, 70%, 80%, 90%) of the population, with a certain confidence (e.g., 70%, 80%, 90%). If answers are coded and/or otherwise combined, various quantitative statistical tests can be applied.

Referring in more detail to generating (214) additional questions based on the received answers, in some embodiments of the invention, presentation station 110 generates questions which probe the reasons for answers to previous questions. Optionally, the generated questions probe the reasons to a statistical distribution of the answers. For example, for an answer which was given by the most respondents and/or was given by a number of respondents above a threshold, a question asking why this answer is so popular, is generated. Alternatively or additionally, for answers given by very few respondents, a question asking why the answer was not selected, is generated. In some embodiments of the invention, a question asking if the question was clear is generated for questions having a low response rate. In some embodiments of the invention, when two answers receive substantially the same agreement levels, a question is formulated to determine which is preferred. Optionally, before formulating the question an attempt is made to ensure that the answers are not equivalent. In some embodiments of the invention, text mining methods are used to determine whether the answers are the same. Alternatively or additionally, the answers are displayed to the moderator who verifies that the answers are not equivalent.

In some embodiments of the invention, when there is a statistically distinct difference between the answers of different groups (e.g., people of different ages, gender, professions), presentation station 110 generates questions probing the reasons of the difference (“why do people above age 50 prefer packaging in bags over cartons?”). Alternatively or additionally, when there is a big difference between the results of the current session and previous sessions, a question is generated to probe for the reasons. In some embodiments of the invention, when respondents rate an answer of a different respondent as unclear, a question asking if they could rephrase the remark is generated. Alternatively or additionally, when respondents having a certain bias answer differently than others, a question asking whether the bias is the cause of the difference, is generated.

Alternatively or additionally, presentation station 110 generates a closed question using answers given to an open question, for example the five most popular answers, the most unpopular answers and/or a combination of popular, unpopular and/or medially provided or rated answers. Alternatively or additionally, the answers used in the closed question are those provided by people with specific profiles, the shortest answers, answers having a correct grammatical structure and/or the first few answers entered. The popularity is optionally determined based on the ratings given to the answers and/or based on an accumulation of similar answers. The answers included in the closed question are optionally ones determined to be different from each other, for example using text mining methods. Alternatively or additionally, the answers included in the closed questions are those which are determined based on text mining methods as most differing.

In some embodiments of the invention, presentation station 110 evaluates the attitude of the respondents to different types of questions, according to the answers of the respondents to previously provided questions. Accordingly, the questions in the roster of questions are optionally converted into a type more suited for the audience of respondents. The conversion may be performed in real time or may be performed by reference to a library of equivalent questions prepared before the survey session. Alternatively or additionally, the conversion is performed by requiring a moderator assistant to perform the conversion during the session. Optionally, at each time point, the moderator assistant performs the conversion of roster questions to be used in the next few moments. For example, if one type of question receives a low answer rate or receives superfluous answers, while another type of question receives a high answer rate and/or detailed answers, questions of the first type are optionally converted into questions of the second type.

The different types of questions may differ, for example, in their length, in using soft words (e.g., dislike) versus strong words (e.g., hate) and/or in the subject of the question (e.g., the respondent, friends, neighbors, people in general). For example, the same idea may be formulated using the following types of questions:

What soap do you prefer?

Which soap is best?

What soap do your friends prefer?

Which soap do people buy?

Questions may be provocative or polite, relate to past, present or future, etc.

It is noted that each question type may involve a bias in a specific direction. Presentation station 110 optionally keeps track of which questions were used and accordingly analyzes the answers received.

Optionally, a question type which receives best results from the respondents is used in a higher frequency than other types of questions. Alternatively or additionally, the questions are converted into different types, or the types are randomly selected, to avoid monotonous question asking.

In some embodiments of the invention, the roster of questions prepared before the survey session includes questions in a canonical format. During the session, presentation station 110 converts (using any of the methods described above) each question being provided to the respondents into a format best suited the audience of respondents, according to information acquired during the session. Alternatively or additionally, the question types used are selected according to predetermined information on the respondents, such as demographic characteristics and/or answering capabilities.

In some embodiments of the invention, the respondents may provide ratings on the questions. These rating are optionally displayed to moderator 128. Alternatively or additionally, based on the ratings, suggested changes to the questions of the roster and/or suggested new questions are provided.

Optionally, in addition to questions generated by presentation station 110, questions received from observers 136 are displayed to moderator 128. In some embodiments of the invention, different observers 136 have different priorities and each suggestion is displayed before moderator 128 according to the priority of the observer providing the suggestion.

In some embodiments of the invention, presentation station 110 prioritizes the displayed questions according to pre-configured rules. The more important questions may be displayed with a unique font attribute (e.g., size, style, color) and/or in a more central place. Alternatively, the questions are displayed in an equal manner without any prioritization provided by station 110.

Referring in more detail to providing (216) answers to other respondents, in some embodiments of the invention, the respondents are divided into sub-groups, and the answers from the respondents of each sub-group are distributed between the respondents of that sub-group. The sub-grouping is optionally performed in order to technically allow the discussion (not too many people talking together) and/or to stimulate a discussion of a specific blend of people.

The sub-groups are optionally of a size which allows the respondents in the sub-group to apprehend the answers from all the other respondents of the sub-group. An exemplary sub-group size includes between about 10-20 respondents. In some embodiments of the invention, the respondents are divided into sub-groups randomly. Alternatively, the respondents are divided into sub-groups according to respondent profiles of the respondents. For example, slow readers may be collected together into a smaller group. In another example, respondents of same age groups may be grouped together. Alternatively or additionally, each sub-group includes a predetermined blend of respondents having different characteristics. The characteristics may include, for example, age, gender, economic status and/or other demographic characteristics. Alternatively or additionally, the characteristics may include verbosity, creativity, and/or other discussion related characteristics.

Optionally, in some implementations, each respondent is only aware of his or her sub-group and does not know of other sub-groups being surveyed at the same time.

In some embodiments of the invention, at the beginning of a survey session, preliminary questions are asked to determine respondent characteristics for the grouping. Alternatively or additionally, respondent characteristics are determined before the survey session, for example based on previous sessions and/or a form filled out prior to the session.

Optionally, a respondent may be included in a plurality of sub-groups. For example, a respondent who is a fast reader and/or writer may be put in a few sub-groups. In some embodiments of the invention, the groups are made relatively small, such that each respondent may be included in two or three groups. When a respondent is included in a plurality of groups, each remark is sent to the group to which it belongs, optionally according to the answer or remark to which the entered remark relates.

Rather than using relatively small sub-groups in which all the members participate in the discussion, in some embodiments of the invention, larger groups are defined, in which only some of the answers and remarks of the respondents are distributed to the other members. For example, groups of 100 members in which only answers from 20 respondents are distributed, may be used. Optionally, the distributed statements are generated by a group of randomly selected respondents. Alternatively, the distributed statements are generated by respondents identified as providing interesting answers, respondents having a high rate of answer generation and/or respondents selected using any other methods. Alternatively or additionally, the distributed statements are selected according to the structure and/or contents of the statements, for example short statements.

Alternatively to having fixed sub-groups throughout the session, in some embodiments of the invention, the sub-group division varies during the session, according to the progress of the sub-groups. For example, one or more respondents from highly active sub-groups may be transferred to a sub-group which is relatively inactive. The transfer is optionally performed between questions, so as not to interrupt in the middle of a discussion. Optionally, the transfer is performed without the respondents being notified of the transfer. Alternatively, the transferred respondents are notified that they are being transferred.

In some embodiments of the invention, the division into sub-groups changes during the session according to the questions which are being answered. Optionally, for questions which are expected to arouse active discussions, smaller sub-groups are defined, than for questions which do not generally arouse discussion. Alternatively or additionally, the division into sub-groups may change due to changes in the profiles of the respondents and/or the data context to which the respondent was exposed.

Having a large number of respondents participating in the discussion, allows the moderator to receive a large amount of qualitative input. It is noted, however, that there may not be a need for so much input on a single subject. Still, the large amount of respondents allows the moderator to receive required amounts of free expression input, even when the number of respondents from which input is required is not known in advance. In an exemplary embodiment of the invention, an important discussion group is defined by the moderator. The moderator follows the discussions in the important discussion group, while the remaining discussion groups are followed by observers 136 and/or their contents are stored for analysis after the survey session. Alternatively, the other respondents do not participate in discussions but rather listen to the discussion of the important group. The listeners may provide ratings to the statements made in the discussion, providing quantitative data on the remarks.

In some embodiments of the invention, instead of transferring only a portion of the generated answers and remarks to other respondents, respondents may receive summaries as shown, for example, to the observers.

The moderator optionally monitors the important discussion group, for example deciding who participates in the group and/or how many respondents are in the important discussion group. For example, when the discussion is not lively enough, more respondents may be added to the group and/or one or more talkative people may be added to the group. Conversely, when the discussion is too dense, one or more respondents may be removed from the group.

Alternatively to having sub-groups in which all respondents receive the remarks and answers of all the other respondents, in some embodiments of the invention, each respondent receives remarks and answers (referred to together as statements) from other respondents according to a personal respondent profile and/or a current state of the respondent. Optionally, the personal profile determines the amount of data received by the respondent. For example, the number of remarks and answers received may depend on the rate of writing and/or reading of the respondent. Alternatively or additionally, the personal profile determines the type of remarks to be provided to the respondent. For example, optimistic respondents may be provided with statements including negative words. In some embodiments of the invention, respondents are provided with statements which disagree with their opinion. Alternatively, respondents are provided with a blend of agreeing and disagreeing remarks according to the respondent's profile. In some embodiments of the invention, respondents receive all remarks which respond to answers that they generated.

In some embodiments of the invention, respondents are provided with statements from people that have different opinions than they have. Optionally, respondents are identified as having different opinions according to the ratings they give. Respondents giving very different ratings to the answers they see are considered having different opinions. Alternatively or additionally, a respondent is considered having opposite opinions if the ratings given to the statements of the respondent have a high disagreement level.

In some embodiments of the invention, when a group of respondents are determined to give similar ratings or otherwise have similar opinions, when one of the respondents of the group agrees with an answer, the others in the group are shown the opposite of the answer.

Optionally, an attempt is made to give an equal exposure to each of the respondent's answers, i.e., each answer is shown to a predetermined number of other respondents. Alternatively or additionally, each answer is given at least a minimal exposure.

In some embodiments of the invention, the number of remarks provided to each respondent depends on the time line of the respondent's session. Optionally, when a respondent is determined to be inactive, the respondent is provided with a relatively large number of answers from other respondents. An active respondent or a respondent having too much activity is optionally provided with fewer answers from other respondents.

Optionally, the time at which the respondent is allowed to see answers from other respondents depends on the respondent's profile. For example, a respondent determined to be a group leader and/or one who has independent thought, is optionally allowed to see answers from other respondents before answering questions. Follower respondents who tend to reiterate answers of other respondents are optionally shown answers from other respondents only after a predetermined amount of time for thought or after the respondent provides a first answer. Optionally, a minimum thought period is defined for one or more of the respondents, in which the respondent is not shown answers of other respondents. Answers of other respondents received during the minimal thought period are optionally accumulated and transmitted to the respondent together, after the minimal thought period. Alternatively, the accumulated answers are provided with a minimal period between the providing of the answers, allowing the receiving respondent to read, comment and/or rate the answers. Alternatively, answers and remarks from other respondents are delayed by a predetermined period, on their transmission to respondents who tend to reiterate answers of other respondents. Further alternatively, only responses which are not expected to fit the respondent's opinion are shown to the respondent before answering. For example, the respondent may be provided with comments from respondents who the respondent disagreed with their answers.

In some embodiments of the invention, respondents are determined to be leaders according to the ratings their answers receive from other respondents. Alternatively or additionally, at the beginning of the session, a test is performed to determine whether the respondent is a leader or follower. Optionally, several test questions (e.g., 3-4) are provided to the respondents along with answers allegedly provided by other respondents. A leader score is given to the respondent according to the similarity between the respondent's answers and the answers provided to the respondent. Alternatively or additionally, the determination of whether a respondent is a leader is performed during the survey session, by comparing the respondent's answers to answers showed to the respondent.

In an exemplary embodiment of the present invention, for each time a respondent repeats an answer of a different respondent, the time between providing a question and providing answers from other respondents is lengthened. For each time the respondent provides an original answer, the time between providing a question and providing answers from other respondents is shortened. Alternatively or additionally, the leader score is assigned to a respondent based on agreement ratings provided by other respondents. Further alternatively or additionally, the leader score of a respondent is a function of the average time that the respondent requires in order to answer questions. A respondent who provides fast responses is optionally given a higher leader score. Further alternatively or additionally, the structure of the respondent's answers are analyzed in providing the leader score. For example, a respondent providing short and concise answers (e.g., including a single verb) are given higher leader scores. Alternatively or additionally, elaborate answers are given high leader scores.

Alternatively or additionally, answers are provided to other respondents after a predetermined number of respondents answered the question. Optionally, the predetermined number of respondents answering the question includes a sufficient number that allows quantitative analysis. Thus, the fact that the other respondents may be biased from the questions does not eliminate the possibility of generating statistically based results.

In some embodiments of the invention, respondent profiles also relate to the extent to which the respondent changes opinions. The change of opinion may be determined using the methods described above for finding leaders.

In some embodiments of the invention, presentation station 110 is pre-programmed with distribution rules which govern the distribution of data. Optionally, during the survey session, moderator 128 may change one or more rules if desired. In some embodiments of the invention, presentation station 110 includes a rule interface which allows moderator 128 to enter changes in the rules in a fast manner. Optionally, a plurality of sets of distribution rules are defined and moderator 128 selects one of these sets of rules to be used. Alternatively or additionally, for each question and/or context, moderator 128 selects a set of rules to be used, optionally if a default set is not desired.

Optionally, the moderator and/or the observers may provide remarks and/or answers as if they are coming from respondents. This may be used, for example, to stimulate discussion.

Referring in more detail to respondents providing (218) remarks to other answers, in some embodiments of the invention, the remarks are free text statements of a free discussion. Alternatively or additionally, the remarks include ratings, for example agree/disagree and/or on a scale of 1-5 or 1-10. Optionally, respondents may provide remarks to remarks of other respondents. In some embodiments of the invention, the remarks are provided in a free discussion manner. Alternatively, remarks are allowed only in direct response to answers. Further alternatively or additionally, remarks are allowed in response to answers or remarks directly related to answers. Optionally, a remark is considered directly related to an answer if the number of remarks connecting the remark to the answer is beneath a predetermined threshold (e.g., between 1-3). Further alternatively, remarks may be made without specific relation to a different answer or remark.

In some embodiments of the invention, at any time, a respondent may provide a remark only to the most current question, answer, and/or remark he/she is displayed. Alternatively, the respondent may relate to one or more previous statements. Optionally, remarks may be entered only with relation to a current context.

Optionally, computer 104 records the statement to which the remark relates and the remark is transmitted to presentation station 110 together with an indication of the statement to which it relates. In some embodiments of the invention, the summary displayed to moderator 128 shows the relation between the remarks provided by the respondents, for example in a tree structure. Optionally, each remark displayed to the moderator is accompanied by the statement to which the remark relates. Alternatively or additionally, each remark displayed to the moderator is accompanied by information on the context of the originator of the remark. The context optionally includes information on the data provided during the survey session to the originator of the remark and/or information on data generated by the originator of the remark during the survey session. Further alternatively or additionally, in order to reduce the amount of data displayed to the moderator, the information on the context is displayed in an abridged format. The abridged format may state a number of data pieces provided to the originator and/or a number of stimulus provided to the originator.

Optionally, the distribution of the remarks depends on the statement to which the remarks relate. In some embodiments of the invention, remarks are always provided at least to the generator of the statement to which they relate. Alternatively or additionally, in embodiments in which not all respondents are in the same context at the same time, statements are distributed only to respondents 102 currently in the same context as the statement to which the remark relates.

In some embodiments of the invention, presentation station 110 controls for each statement provided to a respondent, the input that the respondent may provide on the statement and/or must provide for the statement. The input may include, for example, remarks, ratings and/or no input at all. When a respondent must enter a response, computer 104 may not allow the respondent to proceed without entering the response or may repeatedly remind the respondent that the response is due. Alternatively or additionally, computer 104 warns the respondent that a fine will be deducted from the compensation of the respondent if a response is not provided.

Referring in more detail to deciding (220) when to end the discussion on the current question, in some embodiments of the invention, the moderator follows the discussion and accordingly determines when to move to end the discussion of the present question. Alternatively or additionally, presentation station 110 determines when the discussion dwindles, for example when only few remarks are received. Further alternatively or additionally, presentation station 110 determines when the remarks got carried away from the main subject, for example by identifying that key words representative of the question do not appear in the discussion. According to the determination of presentation station 110 the moderator determines when to proceed to a next question. Alternatively, presentation station 110 ends the discussion of the question automatically.

In some embodiments of the invention, each question is assigned a predetermined amount of time for discussion and when the time is exhausted, the discussion is terminated. Some questions (e.g., closed questions) may, optionally, be given no time for discussion. Optionally, if the discussion dwindles before the time is over, the discussion is terminated early. In such cases, the remaining time is optionally allotted as additional time to other questions or to additional questions added in real time by the moderator. Optionally, closed questions are given less time for discussion than open questions or are not given any discussion time at all.

In the above discussion it was assumed that all respondents move to a new question at the same time. In some embodiments of the invention, however, different respondents may have different question time lines. Optionally, each respondent proceeds through the questions of the roster at his/her own rate according to the rate in which the respondent responds to questions, the amount of data the respondent receives from other respondents and/or the participation of the respondent in discussions with other respondents.

In some embodiments of the invention, constraints are placed on the proceeding of respondents. For example, respondents may be prevented from proceeding beyond a predetermined point of the question roster, for example a concept change point, before the other respondents reach the point. Optionally, for each point at which respondents may be stalled, the roster includes filler questions to be provided to advanced respondents. Optionally, the filler questions are prompts for remarks on answers of other respondents. In some embodiments of the invention, only fast respondents are allowed to provide remarks on other respondents answers, while other respondents may only give ratings or may not refer at all to answers of other respondents. In some embodiments of the invention, when a predetermined number (e.g., 90%) of the respondents reach the change point, slow respondents are moved beyond the point, foregoing their answers to the skipped questions. Alternatively or additionally, respondents are prevented from proceeding at a rate substantially different from other respondents in a sub-group to which they belong.

Alternatively to placing constraints, each respondent may proceed at his/her own pace even if this results in different respondents relating to different contexts at the same time.

In some embodiments of the invention, remarks are passed only between respondents relating to the same question, such that discussions are always linked to a single question. Alternatively, remarks are passed between respondents relating to questions of a same context. Further alternatively or additionally, remarks may be passed also to respondents in other contexts, optionally provided they already answered questions of the context to which the remarks relate.

In some embodiments of the invention, the moderator may define for some or all of the respondents and/or for one or more of the questions, that the respondent cannot participate in the discussion of the question before submitting an answer to the question. Alternatively or additionally, a respondent may be defined not to receive a next question before answering a previous question. Optionally, one or more questions are defined as less important. If a respondent is behind other respondents these questions are omitted in order to allow the respondent to catch up to other respondents.

Optionally, the moderator may provide a question which interrupts the time line of all the respondents. After answering the question, the respondents may return to their time lines, or may continue together along a new time line.

In some embodiments of the invention, each respondent receives data at a rate (or average rate) determined for the respondent. Questions, answers and remarks directed to the respondent are optionally collected in a buffer of the respondent in presentation station 110 and/or on the respective computer 104. Data from the buffer is optionally displayed to the respondent at the determined rate. Optionally, the contents of the buffer are displayed to the respondent in the order of reception. Alternatively or additionally, questions and/or remarks from specific other respondents are given priority in being displayed. In some embodiments of the invention, the rate at which data is provided to the respondent depends on the amount of data in the buffer of the respondent.

Referring in more detail to determining whether (222) to provide an additional question, in some embodiments of the invention, the determination is performed according to whether all the questions in the roster of questions were provided to the respondents. Alternatively or additionally, the survey session is allotted a predetermined amount of time and at the end of this time the session is terminated.

Referring in more detail to selecting (224) an additional question by the moderator, presentation station 110 optionally displays suggested questions and the responses from the respondents in a manner which allows fast decision making by the moderator. The additional question may be selected from the roster, may be adopted from questions suggested by observers and/or by presentation station 110 and/or may be suggested by the moderator.

It is noted that the moderator may identify an important point in the discussion of one of the groups, formulate a question based on the identified point and provide the question to all the respondents. In some embodiments of the invention, however, the question may be provided to all the respondents except for those in the sub-group from which the idea of the question was taken, as the respondents in this sub-group may be biased.

In some embodiments of the invention, all the respondents receive the same question at the same time. Thus, complete results of the question may be provided substantially immediately. Alternatively, different respondents may receive different questions at the same time and/or the same question may be provided to different respondents at different times. For example, the moderator may instruct presentation station 110 to provide a question to each of the respondents. Presentation station 110 optionally provides the question to the buffer of each of the respondents, but the actual delivery time changes with time.

In some embodiments of the invention, the providing of questions is performed by the moderator, while answers and remarks are transferred automatically based on rules governing the transfer. Alternatively or additionally, the moderator may have the questions provided automatically by presentation station 110, according to a predetermined plan, in a manner similar to the transfer of answers. For example, presentation station 110 may be instructed to provide the questions from the roster at a predetermined rate. Optionally, the moderator may interrupt in the automatic provision of questions, when desired. Alternatively or additionally, the predetermined plan may include points in which the moderator is prompted for a decision, for example when two different questions were prepared in advance or when it is expected that additional probing will be required based on the responses.

The plan for providing questions may be, for example, based on a simple time line and/or may depend on other parameters, such as the answers provided by the respondents.

In some embodiments of the invention, the moderator may determine to provide a question only to a portion of the respondents. For example, in order to save time, half the respondents may be given a first question while the other half of the respondents receive a second question. Based on the results from the respondents to which the question was provided, the moderator may decide if to provide the question to the additional respondents. For example, a question receiving feedback that it is unclear or non-interesting may be removed from being provided to other respondents.

In some embodiments of the invention, each question in the roster and optionally those provided by the moderator during the survey session, is associated with an indication of its minimal exposure needs. The exposure needs may include the number of people to which the question is to be provided and/or the demographic, geographic and/or other characteristics of the people to receive the question. For example, a question may be marked as requiring at least 100 respondents, with a blend of 70% men and 30% women. Optionally, when a question is created it may be assigned a default exposure need indication, for example at least 80% of the respondents. Alternatively or additionally, questions may be assigned with a required statistical confidence level.

During the session, the delivery of the questions to the respondents (including which respondents receive each question) is optionally performed automatically by presentation station 110, based on the exposure needs of the question. Alternatively or additionally, questions are associated with a minimal number of responses required. The question may be provided to a predetermined number of respondents and if not enough responses are received more respondents are provided with the question.

In some embodiments of the invention, some respondents may be provided with questions which they are not allowed to answer or they are not required to answer. The display of the question may aid them in participating in a discussion with other respondents.

The question displayed to one or more of the respondents may be adapted to the profile of the respondent. In an exemplary embodiment of the invention, some respondents are provided with closed questions, while other respondents receive half closed questions.

In some embodiments of the invention, the respondents are divided into sub-groups which relate to the questions of the roster in different orders, in order to cancel the effect of the order of exposure on the results. For example, if the survey is directed to evaluating five concepts, the respondents may be divided into five groups, each of which begins its discussion with a different concept. Presentation station 110 optionally automatically governs the provision of questions to each of the groups. Moderator 128 optionally follows the group discussions and accordingly may add/change or remove questions in each of the concepts. Optionally, the change of a question is affected in all the groups which did not already complete the discussion of the change concept. In some embodiments of the invention, the survey session concludes with a series of closed and/or half closed questions which summarize the survey, allowing the moderator to provide questions based on the discussion, to all the respondents.

In some embodiments of the invention, the discussion summary provided to the moderator states for each respondent the concepts to which the respondent was exposed. Alternatively or additionally, in order to simplify the information provided to the moderator, the summary states for each respondent the number of concepts to which the respondent was exposed, and/or which of a predetermined number of general flow threads the respondent followed. It is noted that some respondents may be moved between groups during the session, and therefore the information on the information already viewed by the respondent may be important to understanding the respondents remarks. In some embodiments of the invention, the movements of respondents between sub-groups may be limited to specific flow threads, in order not to have too many possible contexts of the respondents.

The above incorporated PCT publication WO 01/84266 described how to selectively expose information to participants in a mass interaction event. In an exemplary embodiment of the invention, those methods or the methods described herein are used. However, in an exemplary embodiment of the invention, the survey system distributes data not only based on the load of the recipients, but, in some cases, instead or in addition, taking into account statistical requirements and/or a bias of a single (or several) respondent, a (or several) group, a (or several) session and/or a complete survey.

In one example, if a respondent can only tolerate three out of four data items, a test (e.g., statistical analysis) is made to see which one should be dropped, by checking for each one if dropping it will, for example, cause bias, and/or reduce a confidence level below a defined threshold. In another example, data is not forwarded if a statistical analysis shows that a comment from a respondent receiving the data will not significantly improve a statistical requirement or if a goal can be reached without sending the data.

In an exemplary embodiment of the invention, the survey system can also provide a “what-if” functionality, which can, for example, be applied to see if changing data distribution rules in a certain way is likely to affect a statistical confidence level. In an exemplary embodiment of the invention, the “what-if” functionality is supported by simulations which model the activities of respondents under certain assumptions. These assumptions may be changed and/or learned based on the behavior of the respondents so far. In an exemplary embodiment of the invention, the system applies a general what-if scenario to ensure that the survey will not fail, for example, maintaining a cache of available unbiased respondents and ensuring that required goals are met with some leeway, for example so that if a particular respondent leaves suddenly, or otherwise disrupts the survey, meaningful results can still be achieved. Reduced backup goals are optionally defined for such cases.

Referring in more detail to generating (226) a session report, in some embodiments of the invention, the session report includes quantitative data on the answers of the respondents to at least one of the questions. Optionally, the quantitative data includes statistics from all the respondents or substantially all the respondents. The report optionally includes for each question a percentage of respondents giving each of a predetermined number of answers. Alternatively or additionally, the report includes average ratings of one or more questions. Optionally, the report also includes representative remarks made by respondents. Optionally, any of the methods described above for providing the summary to the moderator may be used in generating the report.

In some embodiments of the invention, the report includes ratings provided by the respondents. Alternatively or additionally, the report includes a comparison of various concepts and/or of different demographic groups.

In some embodiments of the invention, the report includes explanations given by the respondents to the quantitative data. Optionally, the report further includes quantitative data on the explanations given to the quantitative data.

It is noted that although the above embodiments are described as utilizing sophisticated communication methods, in some embodiments of the invention, the discussions are performed using relatively simple communication methods, such as chat rooms and/or clipboards. For example, each sub-group may be implemented by a chat room, while closed questions are provided separately.

Although the above description relates to a single moderator, in some embodiments of the invention, a survey session may be moderated by a plurality of moderators connected to different presentation stations 110. Optionally, each of the moderators has a different task. For example, the moderators may control different groups. Alternatively or additionally, one moderator controls the provision of questions while another moderator controls the transfer of remarks. Further alternatively or additionally, the moderators have at least partially overlapping authority. Optionally, when contradicting instructions are received from two moderators, preference is given to instructions of one of the moderators according to a predetermined hierarchy. Alternatively or additionally, the instructions are passed to an arbitrating moderator.

Alternatively to having a moderator, the survey session is governed completely automatically by presentation station 110 (which therefore does not need to have a display). In this alternative, in addition to suggesting questions, station 110 selects the questions to be provided. When a moderator 128 does manage the session, presentation station 110 may be used at different levels of aid and/or control. In some embodiments of the invention, presentation station 110 interprets general rules of the moderator into specific instructions passed to each of the computers 104. Alternatively or additionally, presentation station 110 presents the moderator with information on the consequences of change in a specific rule, for example displaying the number of respondents to be affected. In some embodiments of the invention, moderator intervention is limited to high level rules. Alternatively, if desired, the moderator may give instructions for specific respondents. Optionally, a user friendly interface is used to allow the moderator to insert such instructions.

It is noted that although the above described system allows simple management of large groups, including definition of sub-groups, in some cases it may be desired to break a survey session into separate sessions. This may be done before the survey session begins and/or during the survey session. Optionally, presentation station 110 may be instructed to convert a current sub-group distribution into fixed groups and/or into separate session groups.

Although the above system is described as operating in an on-line real time setup, the invention may also be used in a non-real time set-up, for example a message board setup (e.g., each group or subgroup can have its own message board, which may be linked together by a moderator), in which each respondent periodically logs-in and provides input. In these embodiments of the invention, presentation station 110 may be programmed to alert the moderator to login when sufficient data has been accumulated. The alert may be sent, for example, by a telephone call, SMS message and/or an e-mail message. In some embodiments of the invention, the message board used is controlled, e.g., the respondent cannot view specific zones of the message board until providing an answer. Similarly, the other constraints described above may also be imposed in the message board environment.

Optionally, in these embodiments, the summary provided to the moderator may be more elaborate than for real time survey sessions. Alternatively or additionally, respondents may be instructed to give more elaborate answers. In some embodiments of the invention, when respondents login they are provided with a message board for review. Optionally, if other respondents belonging to a same sub-group are logged in at the same time, the respondents may be given a chance to discuss things on-line as in a chat room. Alternatively, chat discussions are allowed only if they do not cause bias, for example only if all the respondents of a group are on-line at the same time. Further alternatively, respondents do not login but rather respond using e-mail.

It is noted that some of the methods described above for handling one or more types of statements (e.g., remarks, questions, answers) may be used for other types of statements.

In an exemplary implementation of the invention, a survey is conducted for a shampoo on a sample of 300 participants. A goal is set that the achieved results have a 90% confidence on a sample of 80% women and 20% men. A roster of questions is generated for four different shampoo concepts, optionally substantially the same questions being asked for each of the concepts, including various comparison questions. Some of the comparison questions are optionally generated as templates into which two concepts having similar answer levels are later inserted. The roster optionally includes a few opening and/or warming up questions, possibly followed by demographic questions. Thereafter, the roster includes a series of closed questions for each concept, such as “how unique is concept X?”, “how believable is concept X?”, “how likely would you be to purchase concept X?”, “how relevant is concept X to you?”. In addition, the roster optionally includes open questions, such as “what do you like about concept X?”, “what do you dislike about concept X?”. The roster further includes instructions on the transfer of answers to the open questions from men to women, for rating. Alternatively or additionally, sub-groups of women are set to freely discuss each of the concepts, with an unlimited amount of remark transfer. Optionally, random remarks from the discussion are selected and transferred to the men for rating.

Optionally, the roster includes one or more probing points at which the moderator is prompted to ask additional questions based on the data corrected until the probing point.

In preparing the survey, the moderator optionally defines a method to choose and/or rate the concepts. For example, a purchase intent score for “definitely would buy” and “probably would buy” is defined as a most important factor, followed by a uniqueness level which may be used as a tie breaker and/or as a secondary condition. After a best concept is chosen, questions are provided to determine why the concept is best and/or how the concept can be enhanced.

The participants are optionally divided into four sessions of 75 participants or into four sub-groups. In each session, the questions of the roster are presented in a different order of concepts in order to cancel bias. Optionally, brand users and non brand users are identified, and different weights are given to their answers.

During each session, the moderator exposes (displays) an image of each concept on computers 104 and asks the questions from the roster. The moderator may change the questions (generally slightly) based on the discussion and/or statistical results of closed questions. Alternatively or additionally, the moderator may add or remove questions from the roster. A brand manager of the shampoo, serving as observer 136, may optionally ask the moderator to add/modify questions based on the answers, statistical analysis of the answers and/or the remarks.

Throughout the sessions, presentation station 110 optionally displays the answer statistics to the moderator. Optionally, when results from other sessions are available, the results from all the sessions are displayed accumulatively and/or comparatively.

Optionally, after the second session, the research team decides to drop one concept that was rejected in the first two sessions and replace it with a new concept. Therefore the new concept will have only a total sample of 150 respondents and be somewhat less accurate in terms of statistical validity.

It is noted that acts described above as being performed by moderator 128 may also be performed automatically based on pre-configured rules. Optionally, the moderator may interrupt the automatic operation when desired. Furthermore, acts described above as being performed automatically, may optionally be performed by moderator 128. Some of the tasks of the moderator are relatively trivial and may be easily delegated to assistants, so that the moderator can concentrate on the main task of controlling the interactive survey session. Optionally, the tasks passed on to moderator assistants, if at all, are chosen according to the expected or actual load on the moderator.

It will be appreciated that the above described methods and systems of performing surveys may be varied in many ways, including, changing the order of steps performed. In addition, a multiplicity of various features, both of method and of apparatus have been described. It should be appreciated that different features may be combined in different ways. In particular, not all the features shown above in a particular embodiment are necessary in that embodiment or in every similar embodiment of the invention. Further, combinations of the above features are also considered to be within the scope of some embodiments of the invention. Also within the scope of the invention are hardware and/or software combinations and/or computer readable media containing software for carrying out the methods described above. Section heads are provided solely to assist in browsing the application and should not be construed as limiting the applicability of a feature described therein to only that particular section. When used in the following claims, the terms “comprises”, “includes”, “have” and their conjugates mean “including but not limited to”.

1. A method of conducting a survey session, comprising:
providing a plurality of questions to respondents, at least some questions being provided to a plurality of the respondents;
collecting answers to the questions from the respondents;
transferring at least some of the answers to respondents other than those who generated the answers, during the survey session;
collecting responses to the transferred answers, at least some of the responses being qualitative;
providing a summary report which is at least partially based on qualitative responses or answers collected from the respondents; and
adjusting the progression of the survey session, responsive to the provided summary, during the survey session.

2-8. (canceled)

9. A method according to claim 1, wherein at least one of the questions is provided after transferring at least some of the answers to respondents other than those who generated the answers.

10-11. (canceled)

12. A method according to claim 1, wherein the respondents are divided into sub-groups and wherein transferring the answers comprises transferring each answer to respondents in the same sub-group as the respondent generating the answer.

13. (canceled)

14. A method according to claim 1, wherein at least one of the provided questions is generated responsive to statistics on the answers collected from a plurality of respondents.

15. A method according to claim 14, wherein the at least one question is generated automatically.

16. A method according to claim 1, wherein transferring the answers comprises transferring answers from at least one of the respondents to a group of respondents which changes during the survey for different answers of the respondents.

17. A method according to claim 16, wherein the group of respondents receiving the answers changes at least partially according to the contents of the answers.

18. (canceled)

19. A system for conducting a survey, comprising:
a plurality of respondent stations adapted to collect statements from respective respondents;
at least one presentation station adapted to provide questions to the respondent stations for display to the respondents;
a server adapted to provide statements collected by at least one first respondent station to one or more second respondent stations, at least one of the collected statements being generated responsive to a statement provided by the server; and
a report unit adapted to provide a report summarizing qualitative answers or statements provided by the respondents to provided questions.

20-22. (canceled)

23. A system according to claim 19, wherein at least some of the provided questions include closed questions.

24-45. (canceled)

46. A survey system, comprising:
a question provider adapted to provide a question to a plurality of respondents;
an answer input unit adapted to receive answers from the respondents; and
a processor adapted to generate wording for at least one question, responsive to the answers received from the respondents.

47. A system according to claim 46, wherein the processor is adapted to select from a plurality of answers given to an open question, several answers to be used in a closed question version of the open question.

48. A system according to claim 46, wherein the answer input unit is adapted to receive from the respondents ratings of the answers, and wherein the processor uses the ratings in generating the at least one question.

49. A system according to claim 46, wherein the processor is adapted to generate open questions.

50. A system according to claim 49, wherein the processor is adapted to generate an open question which asks for the reason of the statistical distribution of answers to one or more questions.

51. A system according to claim 46, wherein the question provider is adapted to provide at least one question generated by the processor during a same survey session in which the answers used in generating the question were received.

52. A method of conducting a survey, comprising:
providing a question to a plurality of respondents;
receiving answers from at least some of the respondents; and
selecting a delay period suitable for avoiding bias;
providing a first respondent with an answer received from at least one second respondent, delayed by the selected delay period relative to the time the answer was received.

53. A method according to claim 52, wherein providing the answer received from the at least one second respondent comprises providing the answer from the second respondent only after receiving an answer from the first respondent, although the answer from the second respondent was received before the answer from the first respondent.

54. A method according to claim 52, wherein providing the first respondent with an answer from at least one second respondent comprises providing the first respondent with a plurality of answers.

55. A method according to claim 54, wherein providing the first respondent with an answer from at least one second respondent comprises providing the first respondent with fewer than all the answers received from other respondents.

56. A method according to claim 54, wherein providing the first respondent with an answer from at least one second respondent comprises providing one or more answers which fit one or more filtering requirements.

57-69. (canceled)

70. A method of conducting an interactive survey session, comprising:
providing, during a survey session, a first question to a first group of a plurality of respondents, over a computer network;
collecting answers to the first question;
statistically analyzing the collected answers to the first question;
providing, during the survey session, a second question on the reasons to the statistical distribution of the collected answers to the first question, to a plurality of respondents, over the computer network;
collecting answers to the second question; and
providing a statistical tabulation of the answers to the second question.

71. A method according to claim 70, wherein the second question comprises an open question.

72. A method according to claim 70, wherein the second question comprises a request to rate one or more given explanations to the statistics of answers of the first question.

73. A method of conducting a survey, comprising:
setting a survey goal on the statistics to be achieved by the survey;
providing a plurality of questions to respondents;
collecting answers to the questions from the respondents;
transferring at least some of the answers to respondents other than those who generated the answers;
comparing a current state of the survey to the goal; and
controlling the providing of the questions or the transferring of the answers responsive to the comparison.

74. A method according to claim 73, wherein controlling the transferring of the answers comprises determining a number of respondents to receive an answer.

75. A method according to claim 73, wherein transferring at least some of the answers comprises transferring to fewer than all the respondents.

76-87. (canceled)

88. A method according to claim 1, wherein providing the summary is performed in real-time.

89. A method according to claim 1, wherein the summary report comprises a statistical report.

90. A method according to claim 1, comprising displaying the generated summary to a moderator of the survey, during the survey session.

91. A method according to claim 1, wherein providing the summary report comprises grouping similar answers together and stating for each answer the percentage of respondents providing the answer.

92. A method according to claim 1, wherein providing the summary report comprises using text mining methods to analyze the answers.

93. A method according to claim 1, wherein providing the summary report comprises stating for dominant words a number of collected answers including the words.

94. A method according to claim 1, wherein transferring at least some of the answers to respondents other than those who generated the answers comprises transferring to respondents selected responsive to a provided requirement on the number or profile of the respondents to receive the answers.

95. A method according to claim 1, wherein transferring at least some of the answers comprises transferring at least one answer delayed relative to the time the answer was received.

96. A method according to claim 1, wherein adjusting the progression of the survey comprises using the summary report to generate or modify one or more of the questions provided to the respondents.

97. A method according to claim 1, wherein adjusting the progression of the survey session comprises changing a preplanned survey plan.

98. A method according to claim 97, wherein changing a preplanned survey plan comprises skipping at least one question in a question roster of the preplanned survey plan.

99. A method according to claim 97, wherein changing a preplanned survey plan comprises adjusting at least one question in a question roster of the preplanned survey plan.

100. A system according to claim 19, wherein the at least one presentation station is adapted to adjust the provision of questions to the respondent stations responsive to the report from the report unit.

101. A method of conducting an interactive survey session, comprising:
providing a plurality of questions to a plurality of respondents, during the session; and
transferring input generated by at least some of the respondents in response to the provided questions to others of the at least some of the plurality of respondents during the session,
wherein the plurality of questions are provided to at least two of the respondents in different orders.

102. A method according to claim 101, wherein the orders of providing the questions to the respondents is determined by a survey system and not by the respondents.

103. A method according to claim 101, wherein the different orders are predetermined before the survey session.

104. A method according to claim 101, wherein the different orders are determined according to a goal of the survey session.

105. A method according to claim 101, wherein the different orders are determined automatically by a server, in a manner which controls bias.

106. A method according to claim 101, wherein the different orders are determined automatically responsive to information on the respondents.

107. A method according to claim 106, wherein the different orders are determined automatically responsive to profiles of the respondents.

108. A method according to claim 106, wherein the different orders are determined automatically responsive to input from the respondents.

109. A method according to claim 101, wherein the different orders are determined automatically randomly.

110. A method according to claim 101, wherein the session lasts less than three hours.

111. A method according to claim 101, wherein the respondents are divided into sub-groups and wherein transferring the input comprises transferring the input to respondents in the same sub-group as the respondent generating the input.

112. A method according to claim 101, wherein providing the plurality of questions comprises providing visual stimuli for reaction by the respondents.
